(19) United States
(12) Patent Application Publication
(10) Pub. No.: US 2007/0057933 A1
(43) Pub. Date: Mar. 15, 2007

(54) IMAGE DISPLAY APPARATUS AND IMAGE DISPLAY METHOD

(75) Inventors: Tomoyuki Ohno, Zama-shi (JP); Shuntaro Aratani, Machida-shi (JP); Tomoyasu Yoshikawa, Atsugi-shi (JP); Katsuhiro Miyamoto, Isehara-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/530,534

(22) Filed: Sep. 11, 2006

(30) Foreign Application Priority Data
Sep. 12, 2005 (JP) 2005-264437(PAT.)

(51) Int. Cl. G09G 5/00

(52) U.S. Cl. 345/204

(57) ABSTRACT

In an image display method which list-displays a plurality of images including still images and moving images, attention areas are respectively acquired for each image included in the plurality of list-display target images. For instance, if an image is a moving image, a logical OR of attention areas extracted from a plurality of frame images contained in the moving image is deemed to be an attention area of the moving image. Display positions are respectively determined for each of the plurality of images so that the attention areas determined for each of the plurality of images overlap each other while being entirely exposed. List display is performed by respectively laying out each of the plurality of images to the determined display positions.

### BACKGROUND OF THE INVENTION

1. Field of the Invention

The present invention relates to an image display method and an image display apparatus for displaying still images

and/or moving images photographed by a digital still camera, digital video camera or the like.

2. Description of the Related Art

In recent years, digital still cameras (hereinafter referred to as DSCs) and digital video cameras (hereinafter referred to as DVCs) have become popular, and digitization of television sets due to digital telecast has become prevalent. Against the backdrop of the popularization of such technologies, more and more users are viewing still and moving images photographed by DSCs or DVCs on television sets.

When viewing such images on a television set, a typical procedure followed by a user involves first selecting an image from a list of a plurality of images displayed on the screen, and then having the selected image enlarged on the screen. In addition, through enhancement in the capabilities of image signal processing circuits or display processing circuits, it is now possible to simultaneously playback and display a plurality of moving images when displaying a list of a plurality of images.

Furthermore, increases in the capacities of the storage media used in DSCs and DVCs, and in particular of memory cards, have led to increased numbers of images which may be photographed using a single memory card. As a result, users are finding it increasingly difficult to locate a desired image from a list display of such large quantities of image data.

Therefore, an image display method has been desired in which a greater number of image data may be efficiently arranged in a list layout, thereby enabling users to find desired images with ease.

As a technique to list-display a large quantity of image data to be viewed, a viewing apparatus and method are proposed which perform two-dimensional or three-dimensional sorting and layout of visual contents based on their visual and semantic characteristic quantities. Such sorting and layout enable users to efficiently find desired visual images.

However, with conventional technology, it is perceived that important portions for discriminating images may possibly be hidden from view. For instance, in a moving image featuring a person running from the top left towards the bottom central portion of the image, such as the moving image shown in FIG. 32A, the manner in which the person runs is significant. As time advances, the display of the moving image will change from reference numeral 3300 to 3301. Therefore, performing list-display using a formation in which images are partially overlapped, such as those shown on screen 3302 in FIG. 32B, and displaying the image shown in FIG. 32A in a frame 3304 sometimes resulted in important portions of a face being hidden, as shown in FIG. 32C.

Therefore, for the proposal disclosed in the above-mentioned Japanese Patent Laid-Open 2001-309269, it is considered necessary to arrange important portions of images to be visible by having the user select displayed images, or moving positions of virtual points of view and the like. In addition, it is considered necessary in some cases to provide a display area of moving images as a separate area so that important portions become visible.

### SUMMARY OF THE INVENTION

The present invention has been made in consideration of the above problems, and its object is to enable users to display the contents of images more easily in a state in which overlapping list display is performed, which allows overlapping of portions of images, in order to efficiently list-display a large quantity of images on a screen.

According to one aspect of the present invention, there is provided an image display method for list-displaying a plurality of images, comprising: an acquisition step for acquiring an attention area in an image; a determination step for respectively determining a display position for each of the plurality of images so that the plurality of images overlap each other while the attention areas acquired in the acquisition step are entirely exposed; and a display control step for list-displaying the plurality of images by laying out each of the plurality of images to the display positions determined in the determination step.

According to another aspect of the present invention, there is provided an image display method for list-displaying a plurality of images, comprising: a display control step for list-displaying the plurality of images so that portions thereof are overlapping; an extracting step for extracting an attention area from an image; a judgment step for determining whether the attention area extracted in the extracting step overlaps with other images; and an updating step for updating the list display state when the attention area is judged to be overlapping with other images in the judgment step so that the attention area becomes exposed.

Furthermore, according to another aspect of the present invention, there is provided an image display apparatus for list-displaying a plurality of images, the apparatus comprising: an acquisition unit adapted to acquire an attention area in an image; a determination unit adapted to respectively determine a display position for each of the plurality of images so that the plurality of images overlap each other while the attention areas acquired by the acquisition unit are entirely exposed; and a display control unit adapted to list-display the plurality of images by laying out each of the plurality of images to the display positions determined by the determination unit.

Furthermore, according to another aspect of the present invention, there is provided an image display apparatus for list-displaying a plurality of images, the apparatus comprising: a display control unit adapted to list-display the plurality of images so that portions thereof are overlapping; an extracting unit adapted to extract an attention area from an image; a judgment unit adapted to determine whether the attention area extracted by the extracting unit overlaps with other images; and an updating unit adapted to update the list display state when the attention area is judged to be overlapping with other images by the judgment unit so that the attention area becomes exposed.

Further features of the present invention will become apparent from the following description of exemplary embodiments (with reference to the attached drawings).

### BRIEF DESCRIPTION OF THE DRAWINGS

FIG. 1 is a block diagram showing a configuration example of an image display apparatus according to a first embodiment;

FIG. 2 is a diagram showing an exterior view of a remote controller of an image display apparatus applicable to the first embodiment;

FIG. 3 is a flowchart showing the entire generation processing of attention area information;

FIG. 4 is a flowchart showing generation processing of attention area information of a still image;

FIG. 5 is a flowchart showing generation processing of attention area information of a moving image;

FIG. 6 is a flowchart showing face detection processing of a person;

FIG. 7A is a diagram showing an example of image data to be processed by the image display apparatus according to the present invention;

FIG. 7B is a diagram showing an example of a face area judgment result after face detection processing;

FIGS. 8A to 8C are diagrams showing examples of attention areas based on focus position information;

FIG. 8D is a diagram showing an example of an attention area when no focus position information exists;

FIG. 9A is a diagram showing an example of a face area judgment result after face detection processing;

FIG. 9B is a diagram showing an example of attention area information for a moving image;

FIG. 10 is a flowchart explaining processing for an overlapping list display of images according to the first embodiment;

FIG. 11A is a diagram showing examples of attention area information of still images and moving image frames;

FIG. 11B is a diagram showing an example in which the images of FIG. 11A have been stored according to their sizes of attention area information;

FIG. 12 is a diagram showing an example of an overlapping list display of images;

FIG. 13 is a flowchart showing generation processing of attention area information of a moving image according to a second embodiment;

FIG. 14 is a flowchart showing determination processing of a frame distance for generating attention areas of moving images according to the second embodiment;

FIG. 15 is a flowchart explaining processing for an overlapping list display of images according to a third embodiment;

FIG. 16 is a flowchart showing generation processing of attention area information of a moving image according to the third embodiment;

FIG. 17 is a flowchart explaining determination processing of a number of frames for generating an attention area of a moving image;

FIG. 18A is a diagram showing examples of attention area information of still images and a moving image for explaining the third embodiment;

FIG. 18B is a diagram showing an example in which the images of FIG. 18A have been sorted according to their sizes of attention area information;

FIG. 19 is a diagram showing an example of an overlapping list display of images according to the third embodiment;

FIG. 20 is a flowchart showing layout update processing for an overlapping list display of images according to the third embodiment;

FIG. 21 is a flowchart showing processing for relayout position determination of an image;

FIGS. 22A and 22B are pattern diagrams showing a relationship between an arrangement of images newly overlapped as a result of changes in attention area information of a moving image, and attention areas;

FIGS. 23A to 23G are diagrams typically showing an example of operations for performing relayout;

FIG. 24 is a diagram showing a table for determining directions of movement from layout patterns of images;

FIG. 25 is a diagram showing a table for determining an image group to be moved simultaneously with an evaluation target image from the direction of movement of the image;

FIGS. 26A and 26B are diagrams showing an example of an overlapping list display of images before display update;

FIG. 27 is a flowchart showing generation processing of attention area information of a moving image according to a fourth embodiment;

FIG. 28 is a flowchart explaining processing for an overlapping list display of images according to a fifth embodiment;

FIGS. 29A and 29B are diagrams showing an example of an overlapping list display of images before display update;

FIG. 29C is a diagram showing an example of an overlapping list display of images after display update according to the fifth embodiment;

FIG. 29D is a diagram showing an example of an overlapping list display of images after display update according to a sixth embodiment;

FIG. 30 is a flowchart showing relayout position determination processing of images according to the fifth embodiment;

FIG. 31 is a flowchart showing relayout position determination processing of images according to the sixth embodiment; and

FIGS. 32A to 32C are diagrams showing a display example of an image list in the event that the present invention is not used.

### DESCRIPTION OF THE EMBODIMENTS

### First Embodiment

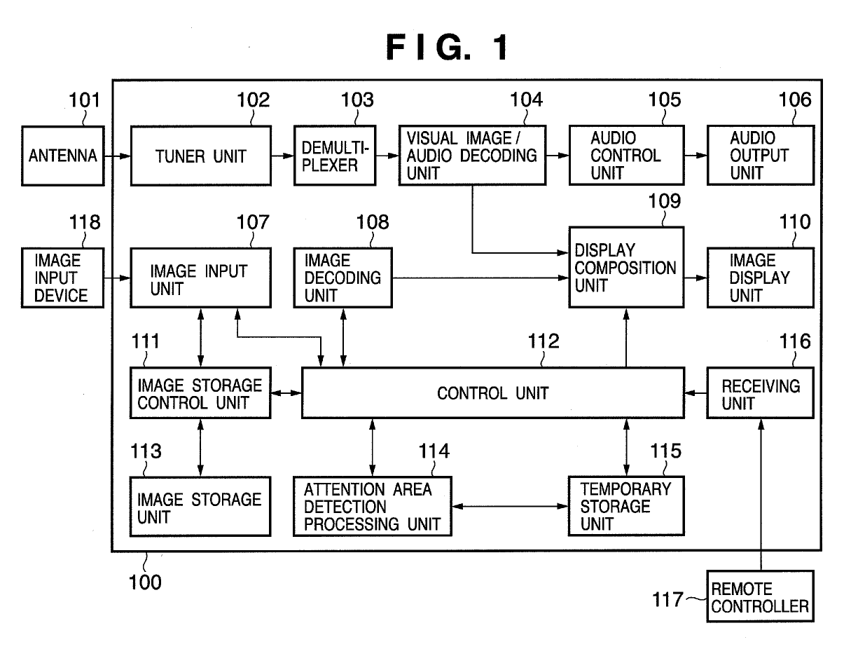

FIG. 1 is a block diagram showing a configuration example of an image display apparatus according to a first embodiment of the present invention. The image display apparatus may be a television receiver such as a flat-screen television, or a display of a personal computer may be used instead.

[Basic Functions of the Image Display Apparatus 100]

In FIG. 1, the image display apparatus 100 is equipped with a function to display visual images and program information related to a channel selected by a user from digital broadcasting signals received via an antenna 101 onto an image display unit 110, according to instructions from a remote controller 117. In addition, the image display apparatus 100 is equipped with a function to output audio signals to an audio output unit 106 via an audio control unit 105. Furthermore, the image display apparatus 100 is equipped with a function to acquire images from a DSC, a DVC or a memory card and the like which is connected as an image input device 118, and a function to display acquired images onto the image display unit 110 according to instructions from the remote controller 117.

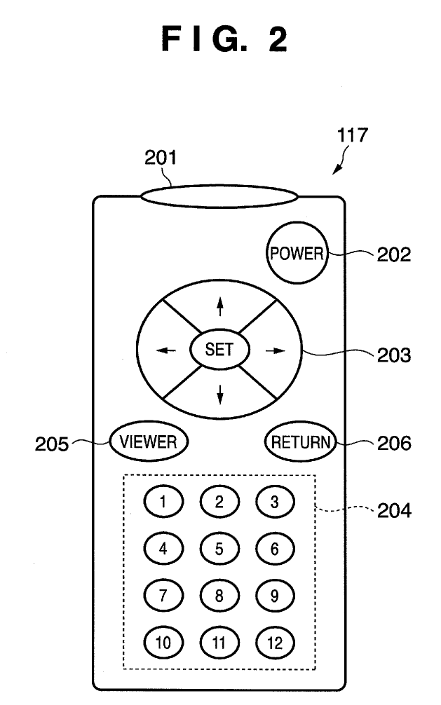

FIG. 2 is a diagram showing an exterior view of the remote controller 117. However, FIG. 2 shows only the keys used to perform the operations for realizing functions necessary for describing the first embodiment, and keys necessary for an actual image display apparatus are not limited to those shown.

In FIG. 2, a transmitting unit 201 performs infrared communication between the remote controller 117 and a receiving unit 116 of FIG. 1. A power key 202 is an operating switch for turning on/off the image display apparatus 100. For a “cursor and decision” key 203, a decision key is arranged at the center of up, down, left and right buttons. For the “numeric” keys 204, numerals from 1 to 12 are arranged in a matrix pattern. A “viewer” key 205 is a key for displaying and deleting an image list display screen, which will be described later. A “return” key 206 is used when returning the state of the screen display to the last state. A user is able to decide various operations of the image display apparatus 100 by operating these various keys on the remote controller 117.

Returning now to FIG. 1, signals received by the antenna 101 are inputted to a tuner unit 102. The tuner unit 102 performs processing such as demodulation and error correction on the inputted signals, and generates digital data of a format referred to as transport stream (TS). The generated TS is outputted to a demultiplexer 103.

The demultiplexer 103 retrieves visual image data and audio data from the TS inputted from the tuner unit 102, and outputs the retrieved data to the visual image/audio decoding unit 104. Multiple channels' worth of visual images and audio data, as well as electronic program guide (EPS) data and data broadcasting data or the like, are time-division multiplexed onto the TS. Visual image data processed by the visual image/audio decoding unit 104 is displayed on the image display unit 110 via a display composition unit 109. Audio data is provided to the audio control unit 105, and is audio-outputted from the audio output unit 106.

[Image Storage Function of the Image Display Apparatus 100]

An image input unit 107 is an interface for loading images from the image input device 118 to the image display apparatus 100, and may assume various forms depending on the image input device 118 to be connected. For instance, if the image input device 118 is a DSC, a USB or a wireless LAN will be used. If the image input device 118 is a DVC, a USB, IEEE 1394 or a wireless LAN will be used. If the image input device 118 is a memory card, a PCMCIA interface or an interface unique to the memory card will be used. When connection of the image input device 118 is detected, the image input unit 107 outputs a connection detection event to a control unit 112.

When the control unit 112 receives the device connection detection event, the control unit 112 displays a screen inquiring the user whether images in the image input device 118 should be stored in an image storage unit 113 on the image display unit 110 via the display composition unit 109. The image storage unit 113 is composed of a non-volatile storage device such as a hard disk or a large-capacity semiconductor memory. The user operates the remote controller 117 while looking at the screen to choose whether images will be stored. Selected information is sent from the remote controller 117 to the control unit 112 via the receiving unit 116. When processing for storing images has been chosen, the control unit 112 loads images in the image input device 118 via the image input unit 107, and controls the loaded images to be stored in the image storage unit 113 via the image storage control unit 111.

It is assumed that the images used in the present embodiment are data of still images and moving images photographed by a DSC. Still image data is data stored in the memory card as a still image file after undergoing JPEG compression processing at the DSC. In addition, moving image data is a group of images stored in the memory card as a moving image file after undergoing JPEG compression processing per-frame at the DSC. As related information associated to images, information upon photography by the DSC is attached to a still image file. Information upon photography includes, for instance, time and date of photography, model name of camera, photographic scene mode, focus position information indicating a focus position within the finder upon photography, flash state information, information indicating distance to subject, and zoom state information. In addition, as information regarding focus positions within the finder upon photography, the DSC of the present embodiment uses information in which any of “left”, “center” and “right” is recorded.

[Attention Area Information Generating Function]

Once images have been stored into the image storage unit 113, the control unit 112 performs generation processing of attention area information for each image in cooperation with an attention area detection processing unit 114 and an image decoding unit 108. A flow of generation processing of attention area information for each image will now be described with reference to a drawing.

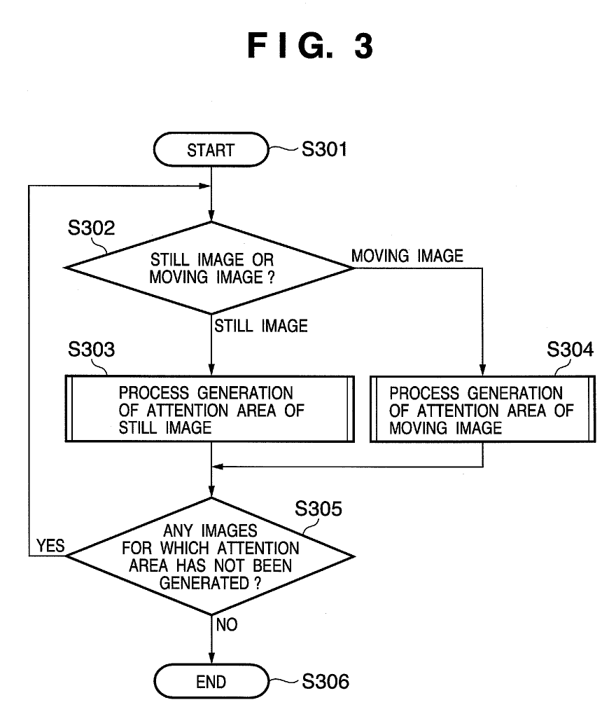

FIG. 3 is a flowchart showing an entire generation processing of attention area information. After the present process is commenced in step S301, in step S302, the control unit 112 judges whether an image among the images stored in the image storage unit 113 is a still image or a moving image, based on extension information of the image file. Regarding extensions of image files, extensions of still images may be, for instance, “.JPG” or “jpg”. Extension of moving images may be, for instance, “.AVI” or “.avi”. Through this judgment, if the image is judged to be a still image, the process proceeds to step S303. On the other hand, if the image is judged to be a moving image, the process proceeds from step S302 to S304.

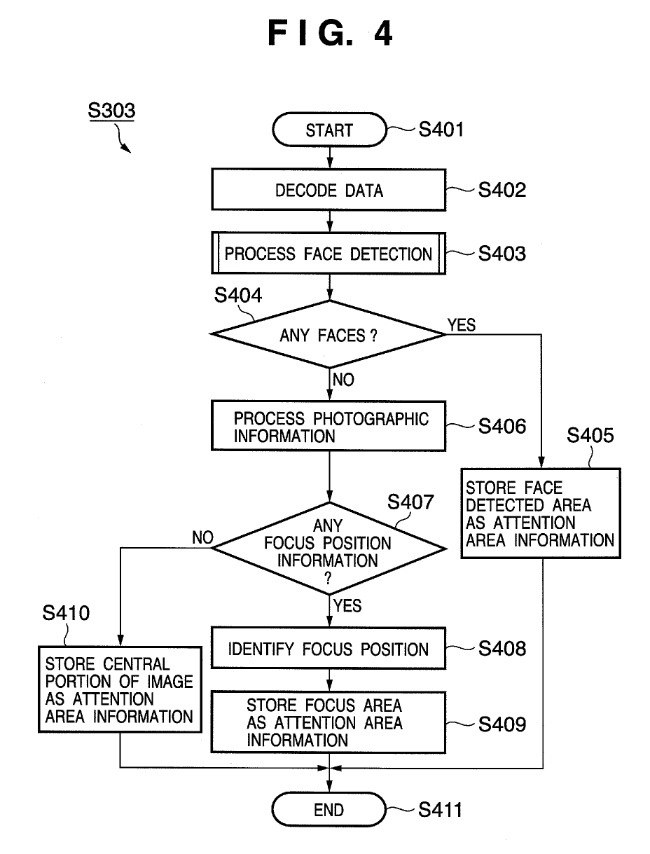

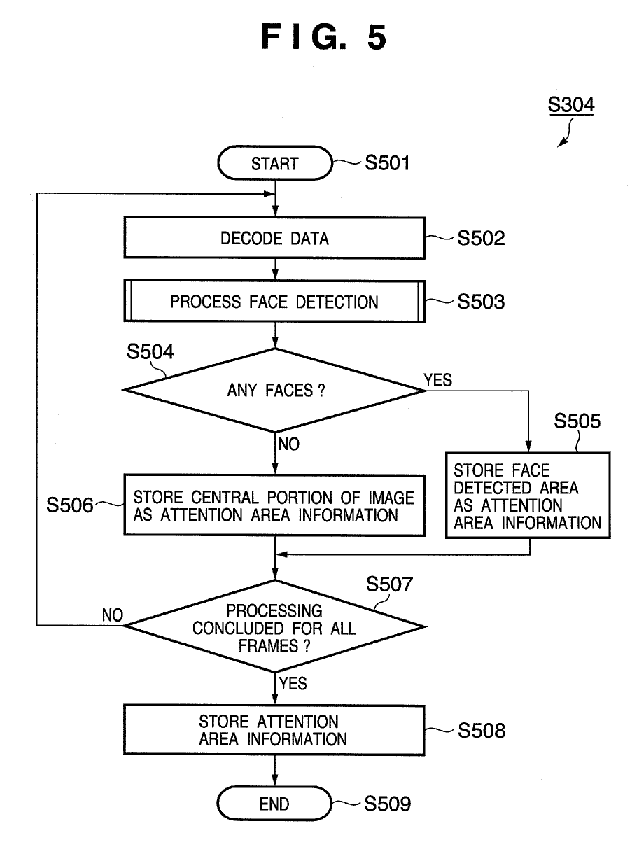

In step S303, the control unit 112 generates attention area information for a still image in cooperation with the attention area detection processing unit 114 and the image decoding unit 108. Details of the processing performed in step S303 will be described later with reference to FIG. 4. In addition, in step S304, the control unit 112 generates attention area information for a moving image in cooperation with the attention area detection processing unit 114 and the image decoding unit 108. Details of the processing performed in step S304 will be described later with reference to FIG. 5.

In step S303 or S304, when generation of attention area information regarding a single image among the images stored in the image storage unit 113 is completed, the control unit 112 judges whether there are any images among all stored images for which attention area information has not been generated. When an image for which attention area information has not been generated exists, the process returns from step S305 to S302 to perform attention area information generating for another image. When generating of attention area information has been completed for all images, the present processing is terminated at step S305.

[Attention Area Generation Processing for Still Images]

As described earlier, in step S303, the control unit 112 generates attention area information for still images in cooperation with the attention area detection processing unit 114 and the image decoding unit 108. Attention area generation processing for still images performed in step S303 will now be described. FIG. 4 is a flowchart for describing generating operations for attention area information for still images.

Generation processing of attention area information for a still image commences in step S401. In step S402, the control unit 112 passes a still image file to the image decoding unit 108. The image decoding unit 108 decodes the JPEG-compressed file, and passes the decoded data to the control unit 112.

In step S403, the control unit 112 passes the data received from the image decoding unit 108 to the attention area detection processing unit 114. The attention area detection processing unit 114 judges whether a human figure exists in the still image data. In the present embodiment, such judgment is performed by detecting the face of a person.

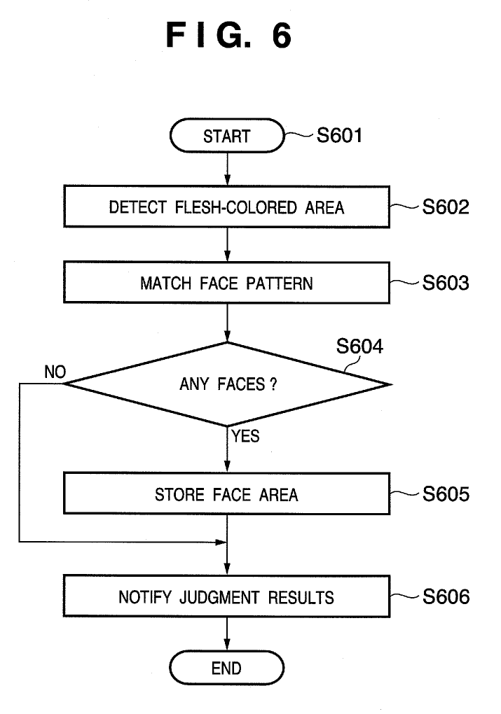

FIG. 6 is a flowchart describing the face detection processing performed in step S403. Face detection operations by the attention area detection processing unit 114 will now be described with reference to the flowchart of FIG. 6. In step S601, the attention area detection processing unit 114 commences judgment processing as to whether a human figure exists in the received data.

In step S602, the attention area detection processing unit 114 executes processing for locating areas containing flesh-colored data in the received data. Next, in step S603, the attention area detection processing unit 114 executes pattern matching processing for the flesh-colored areas extracted in step S602 using shape pattern data of eyes and mouths which are patterns indicating facial characteristics. As a result of the processing of steps S602 and S603, if a face area exists, the process proceeds from step S604 to S605. If not, the process proceeds to step S606. In step S605, based on the judgment results of step S603, the attention area detection processing unit 114 writes information regarding an area (face area) which has been judged to be a face area into a temporary storage unit 115. In step S606, the attention area detection processing unit 114 passes the judgment results on whether a human figure exists in the received data to the control unit 112 to conclude the present process.

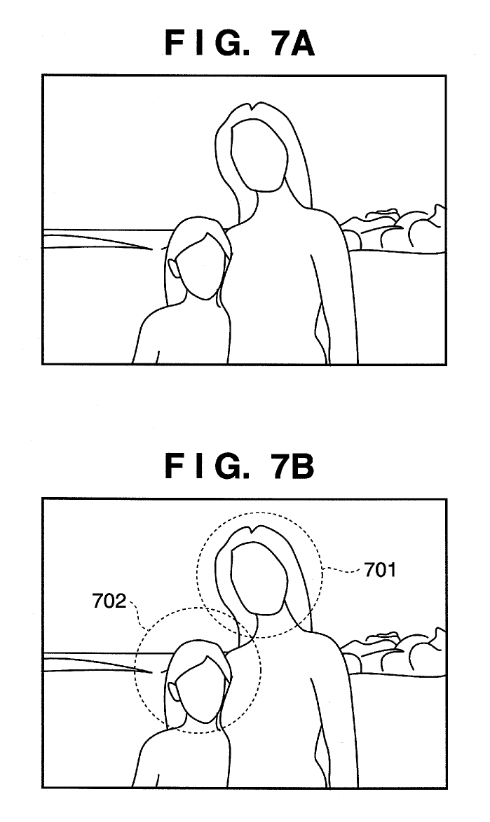

FIG. 7A shows an example of image data to be processed by the attention area detection processing unit 114. In the image data, an adult female and a female child are photographed as subjects. FIG. 7B shows an example of an attention area judgment result after face detection processing by the attention area detection processing unit 114. As shown in FIG. 7B, the areas judged to be face areas are the portions denoted by reference numerals 701 and 702. In the present embodiment, face areas are recognized as circular graphic data, as shown in FIG. 7B. In other words, the face areas stored in step S605 are circular graphic data such as those represented by reference numerals 701 and 702 shown in FIG. 7B.

Returning now to FIG. 4, based on the judgment results from the attention area detection processing unit 114, the control unit 112 judges whether a face exists within the processed still image data. If so, the process proceeds from step S404 to S405. On the other hand, if a face does not exist, the process proceeds from step S404 to S406.

In step S405, based on the processing results from the attention area detection processing unit 114, the control unit 112 stores the face detected area as attention area information into the image storage unit 113. Attention area information is stored to correspond to each image. Attention area information to be stored includes, for instance, the number of attention areas, coordinate values of central points of each attention area, and the diameter of the circles. The process proceeds to step S411 after storing the attention area information to conclude the processing of FIG. 4, or in other words, the processing of step S303.

Meanwhile, attention area generation processing in a case where no faces exist in the image data will be described. When no faces exist, the process proceeds from step S404 to step S406, and the control unit 112 retrieves Exif header information included in the still image file. In step S407, the control unit 112 judges whether the Exif header information retrieved in step S406 includes focus position information associated thereto during photography. If focus position information exists, the process proceeds from step S407 to step S408. If focus position information does not exist, the process proceeds from step S407 to step S410.

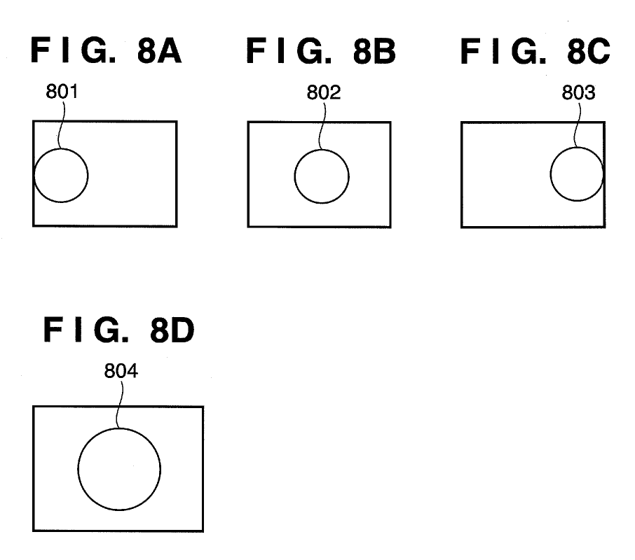

In step S408, the control unit 112 performs identification of a focus position based on focus position information. As described earlier, any of “left”, “center” or “right” is recorded as focus position information. Therefore, in the present embodiment, any of “left”, “center” or “right” is identified by referencing the focus position information. Next, in step S409, the control unit 112 judges the attention area based on the identification results of the focus position in step S408, and stores the attention area. Examples of attention area judgment results based on focus position information are shown in FIGS. 8A to 8C. With the attention areas based on focus position information according to the present embodiment, center positions vary for each focus position, and a plurality of patterns are provided which comprise circular shapes having radii equivalent to ⅙ of the long sides of the shapes. Attention area 801 in FIG. 8A depicts a case where the focus position is at “left”; attention area 802 in FIG. 8B depicts a case where the focus position is at “center”; and attention area 803 in FIG. 8C depicts a case where the focus position is at “right”. The control unit 112 stores attention area information based on the identification results of the focus positions into the image storage unit 113. Information to be stored is information regarding coordinate values of central points of each attention area and radii of the circles. After the information is stored, the present process is terminated.

On the other hand, if there is no focus position information in step S407, the process proceeds to step S410. In step S410, as shown as area 804 in FIG. 8D, the control unit 112 stores, as the attention area information, a circular shape with a radius of ¼ of the long side of the shape and the central portion of the image as its center position, in the image storage unit 113. Information to be stored is coordinate values of the central point of the attention area and the radius of the circle. After the information is stored, the present process is terminated.

[Attention Area Generation Processing for Moving Images]

As described earlier, in step S304, the control unit 112 generates attention area information for moving images in cooperation with the attention area detection processing unit 114 and the image decoding unit 108. Attention area generation processing for moving images performed in step S304 will now be described. FIG. 5 is a flowchart for describing generating operations for attention area information for a moving image.

In step S502, the control unit 112 passes a moving image file to the image decoding unit 108. The image decoding unit 108 decodes one frame's worth of data from the file created by per-frame JPEG-compression processing, and passes the decoded data to the control unit 112.

Next, in step S503, the control unit 112 passes the decoded data received from the image decoding unit 108 to the attention area detection processing unit 114. The attention area detection processing unit 114 judges whether a human figure exists in the moving image frame data. In the present embodiment, such judgment is performed by detecting the face of a person. Since the detection processing is similar to that performed in the case of still images (FIG. 6), as described earlier, a detailed description thereof will be omitted.

As a result of the face detection processing of step S503, if a face exists in the processed moving image frame, the process proceeds from step S504 to step S505. In step S505, based on the processing results from the attention area detection processing unit 114, the control unit 112 stores the face detected area as an attention area information into the image storage unit 113. Area information to be stored is information regarding the number of attention areas, coordinate values of central points of each attention area and radii of the circles. After the information is stored, the process proceeds to step S507. On the other hand, if a face does not exist in the processed moving image frame after the face detection processing of step S503, the process proceeds to step S506. In step S506, as shown in FIG. 8D, the control unit 112 stores the central portion of the image as attention area information in the image storage unit 113. Attention area information to be stored is information regarding the number of attention areas, coordinate values of central points of each attention area and radii of the circles. After the information is stored, the process proceeds to step S507.

In step S507, judgment is performed on whether the above-described processing for determining whether a human figure exists in the moving image frame data (S502 to S506) has been performed on all frames of the present image file. The above-described steps S502 to S506 are repeatedly executed until processing of all frames is completed. Once the processing is completed, the process proceeds to step S508. In step S508, the control unit 112 collectively stores the attention area information stored in the above-mentioned steps S505 and S506. Information to be stored is information regarding the number of attention areas of all frames, coordinate values of central points of each attention area, and radii of the circles, for all frames. Once the attention area information is stored in step S508, the process is concluded.

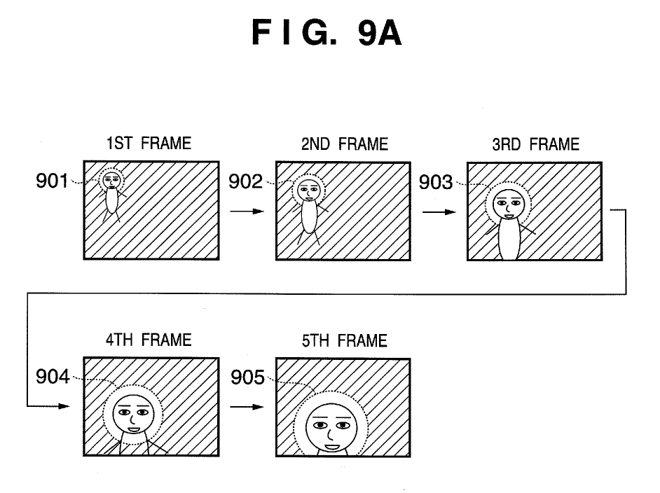

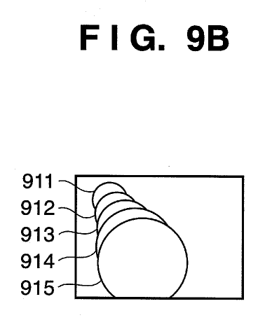

FIG. 9A shows an example of an attention area judgment result after face detection processing by the attention area detection processing unit 114. FIG. 9A is a diagram showing an example of a result of attention area detection processing for a 5-frame moving image data (actual number of frames are not limited to this number). In the moving image shown in FIG. 9A, a person is photographed running up from the top left of the image. In FIG. 9A, the areas which have been judged to be face areas are the areas denoted by reference numerals 901, 902, 903, 904 and 905. As shown in FIG. 9B, areas which have been detected as face areas as shown in FIG. 9A are collectively stored as attention area information of all frames. The circular areas 911, 912, 913, 914 and 915 of FIG. 9B respectively correspond to the circular areas 901, 902, 903, 904 and 905 of FIG. 9A.

In the present embodiment, a logical OR operation of these attention areas is performed to obtain an attention area of the moving image. Processing for obtaining the logical OR is, for instance, performed in step S508.

[Image Overlapping List Display Function of Image Display Apparatus]

Image list display according to the first embodiment will now be described. In the image list display according to the present embodiment, overlapping list display which allows a portion of an image to overlap with a portion of another image is performed in order to increase the number of images to be list-displayed on a single screen. Image list display by the image display apparatus 100 according to the present embodiment is initiated when the user operates the “viewer” key 205 of the remote controller 117 to invoke a viewer function.

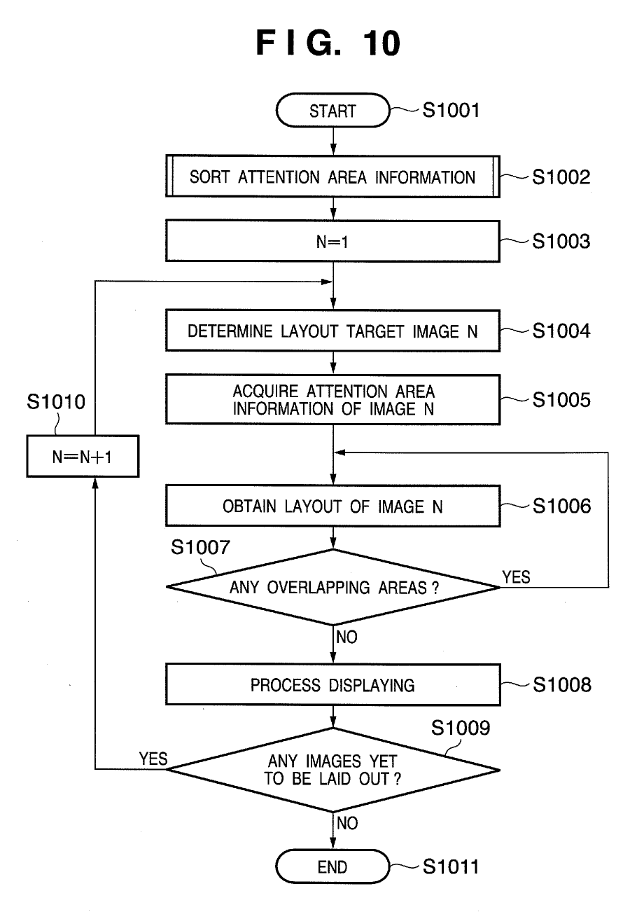

FIG. 10 is a flowchart describing image list display processing performed by the viewer function of the first embodiment. The list display processing shown in FIG. 10 mainly depicts operations performed by the control unit 112. List display processing performed in the first embodiment will now be described according to the flowchart shown in FIG. 10.

When the user presses the “viewer” key 205 of the remote controller 117, shown in FIG. 2, the control unit 112 receives signals from the remote controller 117 via the receiving unit 116 and initiates operations. In step S1002, the control unit 112 reads out per-image attention area information stored in the image storage unit 113, and sorts the images according to the dimensions of attention areas based on radius information thereof.

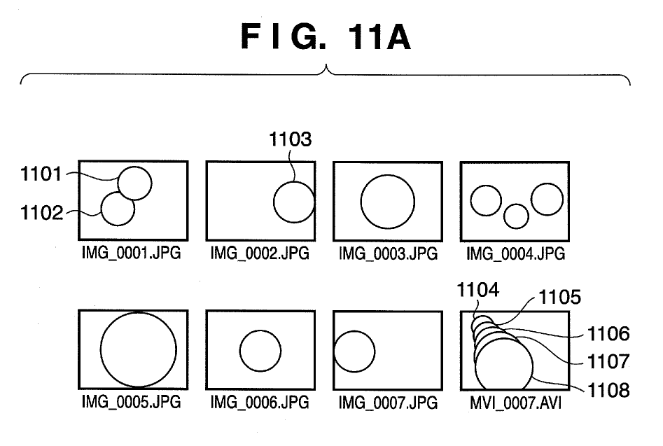

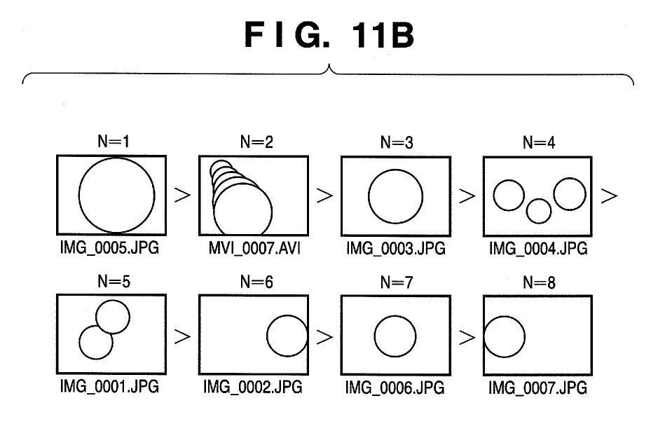

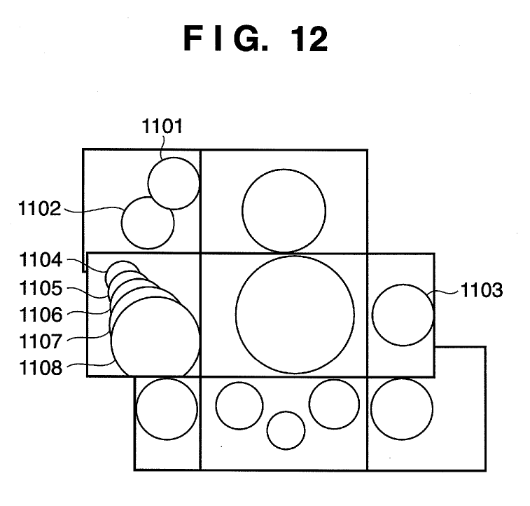

FIG. 11A shows an example of attention area information of eight images used for describing the present embodiment. Reference numerals 1101 and 1102 denote attention area information of the still image whose file name is IMG_{—}0001.JPG. Reference numeral 1103 denotes attention area information of the still image whose file name is IMG_{—}0002.JPG. The same holds for other images, in which the circular shapes represent attention area information of each image. In addition, reference numerals 1104 to 1108 denote attention area information for each frame of the moving image whose file name is MVI_{—}0007.AVI. In the case of a moving image, a logical OR operation is performed on the per-frame attention area information 1104 to 1108 to obtain a dimension of a single attention area. In the present step S1002, the files are sorted in descending order of the dimension of attention area per image, as described earlier. The result of this processing is as shown in FIG. 11B. In other words, the files are sorted in descending order of the dimension of attention area, namely: IMG_{—}0005.JPG, MVI_{—}0007.AVI, IMG_{—}0003.JPG, . . . , IMG_{—}0006.JPG, IMG_{—}0007.JPG.

Next, in step S1003, control unit 112 sets 1 which indicates a first image, to a variable N which indicates a processing sequence of target images to be subjected to layout position determination processing. In the present embodiment, overlapping is arranged so that the greater the value of N, the further the image will be positioned towards the back. In addition, since processing will be performed in the descending order of attention area dimension, the processing target image at N=1 is IMG_{—}0005.JPG. A processing target image is the image targeted for layout position determination in the list display, and will hereinafter be referred to as layout target image.

In step S1004, the control unit 112 determines a layout target image based on the value of the variable N which indicates a processing sequence of layout target images. Next, in step S1005, the control unit 112 acquires attention area information of the layout target image determined in step S1004. In step S1006, the control unit 112 determines a layout position of the layout target image based on acquired attention area information. Determination of coordinate values is arranged to select a position where maximum exposure of the acquired attention area is achieved, and at the same time non-attention areas are hidden as much as possible by images further towards the front. Therefore in step S1007, the control unit 112 judges whether an image further towards the front (an image for which a layout has been determined at an N that is smaller than the current N) overlaps the attention area of the layout target image. If it is judged that an overlap exists, the process returns to step S1006 to reattempt layout position determination. If it is judged that an overlap does not exist, the process proceeds to step S1008. In this manner, step S1006 will be repeatedly performed until a layout is determined in which there are no overlaps involving the attention area.

Next, in step S1008, the control unit 112 displays the layout target image for which a layout has been determined onto the image display unit 110 via the display composition unit 109. If the layout target image is a still image, a thumbnail image is readout and decoded by the image decoding unit 108 to be displayed. In the case of a moving image, the first frame data of the moving image is decoded by the image decoding unit 108, and the size is modified to be displayed. Subsequently, in step S1009, the control unit 112 judges whether an image exists for which layout processing for list display must be performed. If so, in step S1010, the control unit 112 adds 1 to the variable N which indicates an image processing sequence, and returns the process to step S1004 to obtain a next layout target image. Steps S1004 to S1008 are repeated in this manner until there are no more images for which layout processing must be performed. When there are no more images for layout processing, the present process terminates in step S1009.

FIG. 12 is a diagram showing an example of image overlapping list display which is displayed after executing the layout processing depicted in the flowchart shown in FIG. 10 on the eight image files shown in FIGS. 11A and 11B. As seen, each still image and moving image shown in FIG. 11A are displayed so that their attention areas are not hidden (overlapped) by other images. Therefore, according to the above-mentioned list display, contents may be verified in a favorable manner even with moving images in which attention areas move with the lapse of reproduction time.

Incidentally, while an example displaying only eight images on a screen has been indicated in the above description for the sake of simplicity, it is needless to say that a much larger quantity of images may be displayed instead. In addition, the present invention may be arranged so that images inside a memory card or a digital camera are loaded one at a time, and attention area information is calculated by performing the steps S302 to S304 in FIG. 3 before saving the image files and attention area information. Furthermore, storing of attention area information may be automatically initiated upon connection of a memory card or a digital camera by the user. In any case, the overlapping list display shown in FIG. 12 may be achieved, thereby enabling attention areas of the images to be displayed without overlapping other images.

As seen, in the first embodiment, when a plurality of images including moving images is overlapped and list displayed on a screen, a logical OR of the attention areas of a plurality of frames of the moving image is deemed the attention area of a moving image, and the moving image is laid out so that its attention area is not overlapped by other images. This increases the likelihood of the attention area being exposed on the screen even when movement of the attention area occurs due to reproduction of the moving image, and improves the identifiability of the subject in the moving image. Therefore, a user may now find a desired moving image with greater ease when a plurality of images, including moving images, is in a state of overlapping list display on a screen.

### Second Embodiment

In the first embodiment, when generating attention area information for moving images, attention areas were extracted from all frames, as shown in FIG. 5. However, when a moving image contains a large number of frames, processing for extracting attention areas from all the frames will be time-consuming. In this light, with a second embodiment, attention areas will be extracted from selected frames of a moving image.

In the second embodiment, when generating attention area information for a moving image, a distance for selecting frames to be used for generating attention areas is determined from a frame rate (the number of frames to be displayed in one second) of the moving image. The configuration of an image display apparatus to which the second embodiment will be applied is similar to that of the first embodiment (FIG. 1). For the second embodiment, modifications have been made to the image decoding unit 108, the control unit 112 and the attention area detection processing unit 114. In addition, images to be used in the second embodiment are similar to those used in the first embodiment, and are still images and moving image data photographed by a DSC.

Generation processing of attention area information for a moving image, performed in cooperation by the image decoding unit 108, the control unit 112 and the attention area detection processing unit 114, will now be described with reference to the drawings.

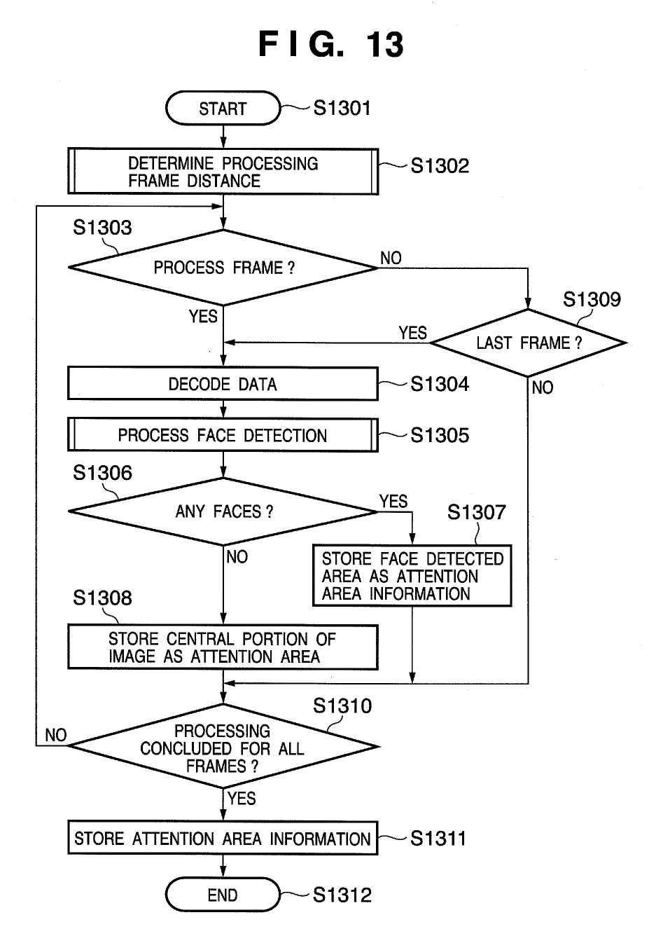

FIG. 13 is a flowchart showing generation processing of attention area information of a moving image according to the second embodiment. The processing shown in FIG. 13 replaces the processing of the first embodiment, shown in FIG. 5.

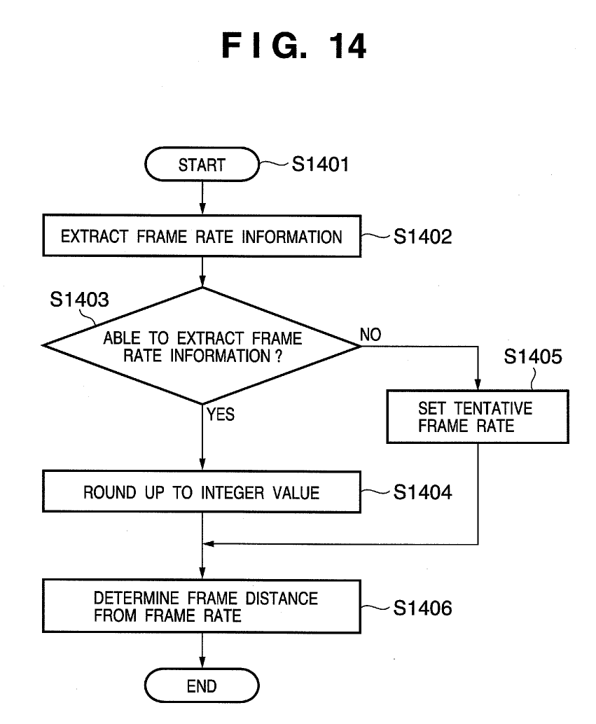

After generation processing of attention area information of a moving image is initiated, in step S1302, the control unit 112 acquires information regarding a frame rate used during moving image reproduction from header information included in the loaded moving image file, and determines a frame distance for generating attention areas. FIG. 14 is a flowchart showing operations for determining a frame distance for generating attention areas.

In step S1402, the control unit 112 extracts frame rate information from the header information of the loaded moving image file. Frame rate information of a moving image file is, for instance, information indicating a reproduction frame rate of 29.97 fps (frames per second) or 30 fps.

Next, in step S1403, the control unit 112 judges whether frame rate information has been properly extracted in the previous step S1402. If frame rate information has been properly extracted, the process proceeds from step S1403 to S1404. In step S1404, the control unit 112 performs round up processing so that the frame rate value extracted in the previous step S1402 assumes an integer value. For instance, an extracted frame rate value of 29.97 fps is rounded up to 30, while 59.94 fps is rounded up to 60. On the other hand, in the event that frame rate information was not extracted in step S1402, the process proceeds from step S1403 to S1405. In step S1405, the control unit 112 sets a tentative frame rate value to the moving image file. In the second embodiment, a tentative frame rate value of, for instance, “5 fps” is set.

In step S1406, the control unit 112 determines the integer value (frame rate value) determined in either step S1404 or S1405 as the frame distance for generating attention areas. For instance, in the case of 29.97 fps, a frame rate value of 30 is obtained, meaning that one frame for every 30 frames will be selected as a processing frame. Once frame distance information is determined as described above, the frame distance information and the moving image file data are handed over to the image decoding unit 108, thereby concluding the frame distance determination operation for generating attention areas.

Returning now to FIG. 13, in step S1303, the image decoding unit 108 judges whether an attention area should be generated for the current frame, based on frame distance information for generating attention areas received from the control unit 112. If the current frame is a frame for which an attention area must be generated, the process proceeds to step S1304.

In step S1304, the image decoding unit 108 decodes one frame's worth of data from the file created by per-frame JPEG-compression processing, and passes the decoded data to the control unit 112. In step S1305, the control unit 112 passes the data received from the image decoding unit 108 in step S1304 to the attention area detection processing unit 114. The attention area detection processing unit 114 judges whether a human figure exists in the moving image frame data. As was the case with the first embodiment, this judgment will be performed in the second embodiment by detecting the face of the human figure. Since the face detection processing to be used is similar to that of the first embodiment (FIG. 6), a detailed description thereof will be omitted.

In step S1306, the control unit 112 judges whether a face has been detected in the processed moving image frame data based on processing results of the attention area detection processing unit 114 (step S1305). If a face has been detected, the process proceeds from step S1306 to step S1307. In step S1307, based on the processing results from the attention area detection processing unit 114, the control unit 112 stores the area detected as a face as attention area information into the image storage unit 113. Information to be stored is the number of attention areas, central point coordinate values of attention areas, and radii of circles indicating the attention areas. On the other hand, if a face has not been detected by the attention area detection processing unit 114 in step S1305, the process proceeds from step S1306 to step S1308. In step S1308, as shown in FIG. BD, the control unit 112 stores the central portion of the image as attention area information in the image storage unit 113. Information to be stored is a number of attention areas, coordinate values of central points of each attention area and radii of the circles.

Once an attention area is determined through the processing of either step S1307 or S1308, the process proceeds to step S1310. In step S1310, judgment is performed on whether the attention area judgment processing of steps S1303 to S1308 has been performed on all frames. The processing of steps S1303 to S1308 is repeated until the above-described processing has been performed on all frames.

In step S1303, if the frame is judged not to be a processing target frame, the process proceeds to step S1309. In step S1309, the image decoding unit 108 judges whether the current frame is the final frame of the current moving image file. If so, the process proceeds to step S1304 to set an attention area. This processing ensures that attention areas are stored for all final frames. If the frame is not a final frame, the process proceeds from step S1309 to S1310, and returns to step S1303 to perform processing for a next frame.

As seen, once the above-described processing is completed for all of the frames of the moving image, the process proceeds from step S1310 to S1311. In step S1311, attention area information stored in steps S1307 and S1308 are collectively stored. Information to be stored is information regarding the number of attention areas in all frames selected as processing frames, coordinate values of central points of each attention area, and radii of the circles. After attention area information is stored, the control unit 112 concludes generating operation of attention area information of moving images shown in FIG. 13.

Overlapping list display of images according to the second embodiment is similar to the method of the first embodiment. Since attention areas are set by extracting frames from all periods of a moving image, contents of moving images may be verified in an effective manner in an overlapping list display even when attention area information moves due to an elapsed time of reproducing a moving image.

As seen, the second embodiment is arranged so that frames for which attention areas will be generated are determined from a frame rate of a moving image during generating of attention area information for the moving image. Therefore, generation time for attention area information may be shortened as compared to the first embodiment in which attention areas are generated from all frames, thereby allowing image overlap list display to be performed at a higher speed.

### Third Embodiment

A third embodiment will now be described. In the third embodiment, storing of images and generation of attention area information are automatically performed when the user connects a memory card or a digital camera, and overlapping list display is performed. Additionally, in the third embodiment, a number of frames for which attention areas will be generated is arranged to be determined from the number of frames existing within a predetermined time during the generation process of attention area information. Moreover, in the third embodiment, overlapping image display is automatically updated to maintain viewability during list display when the reproduction of a moving image displayed as an overlapping list causes attention areas to move and overlap other images. A detailed embodiment of the third embodiment will now be described. The configuration of an image display apparatus 100 according to the third embodiment is similar to that of the first embodiment (FIG. 1), and a detailed description thereof will be omitted.

Image Overlapping List Display Function of Image Display Apparatus]

Overlapping list display of images according to the third embodiment will now be described.

List display of images by the image display apparatus 100 according to the third embodiment is initiated when the user connects an image input device 118 to the image display apparatus 100.

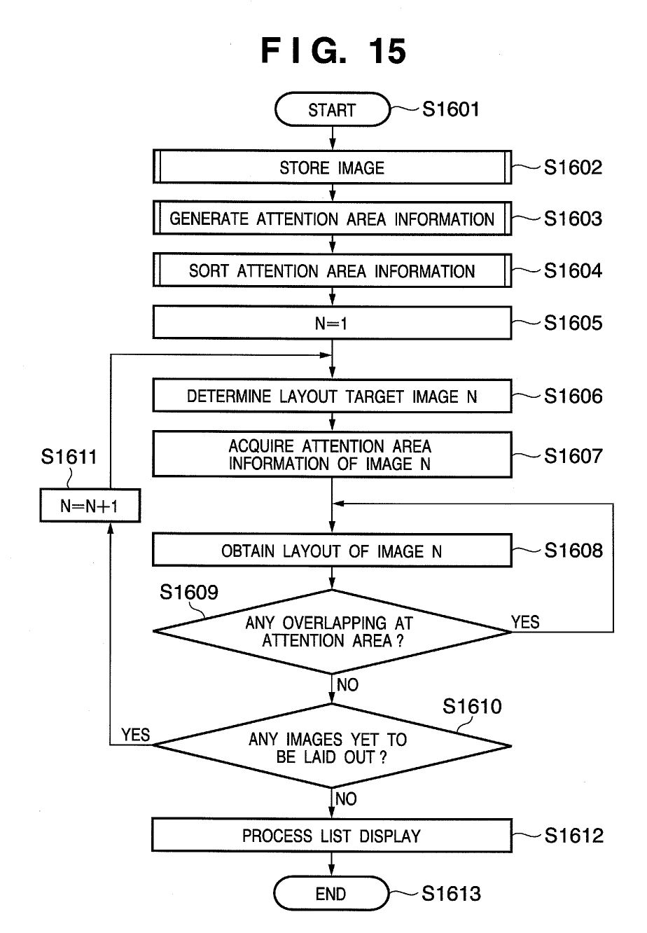

FIG. 15 is a flowchart describing image list display processing performed by the viewer function of the third embodiment. The list display processing is primarily executed by the control unit 112.

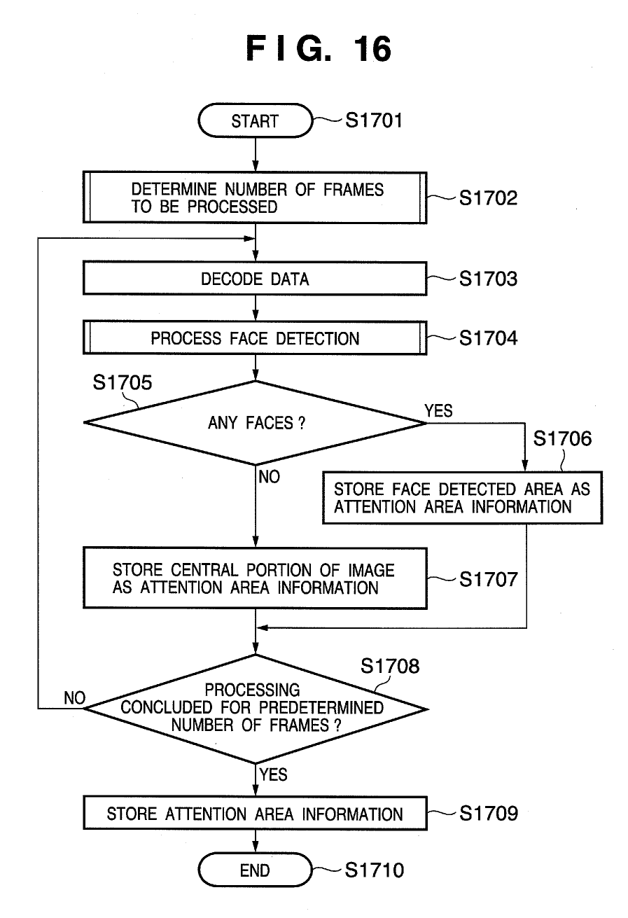

When the user connects the image input device 118 to the image display apparatus 100, the control unit 112 receives a device connection detection event from the image input unit 107 and commences operations. In step S1602, the control unit 112 loads all images in the image input device 118 via the image input unit 107, and controls the images so that the images are stored in the image storage unit 113 via the image storage control unit 111. Next, in step S1603, the control unit 112 performs generating operations of attention area information of the images stored in step S1602. Generation processing for attention area information is as described by the flowchart shown in FIG. 3. While the attention area generation processing for still images of step S303 is as described with reference to the flowchart of FIG. 4, in the third embodiment, the attention area generation processing for moving images of step S304 will be the processing of the flowchart shown in FIG. 16.

In step S304, the control unit 112 executes the processing shown in FIG. 16 in cooperation with the image decoding unit 108 or the attention area detection processing unit 114, and generates attention area information for a moving image. Attention area generation processing for moving images performed in step S304 will now be described.

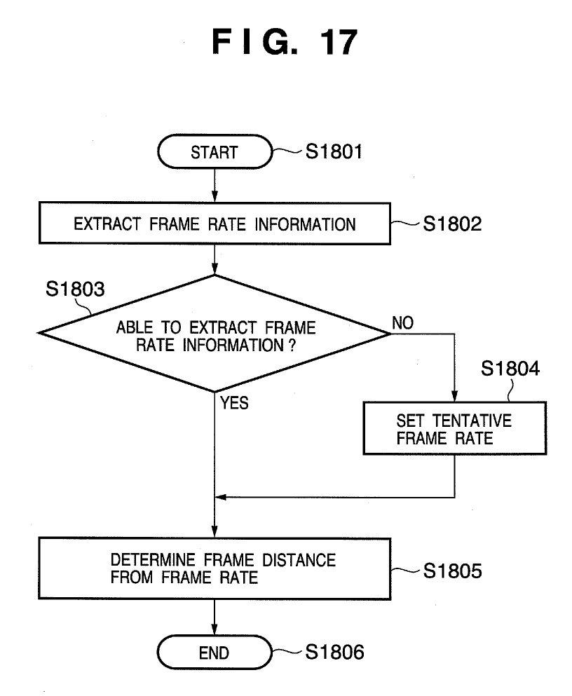

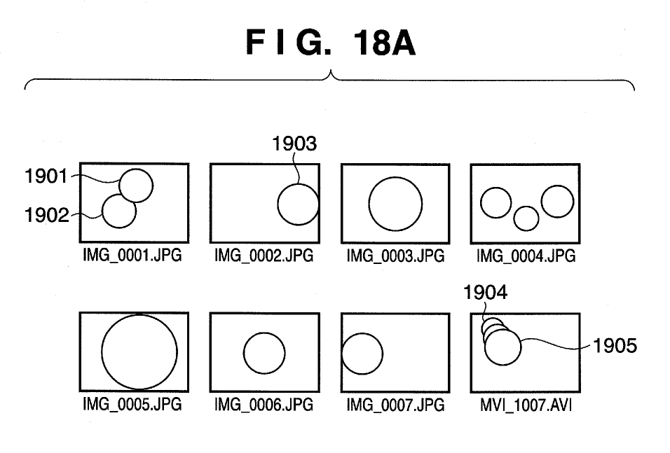

First, in step S1702, the control unit 112 acquires information regarding a frame rate used during moving image reproduction from header information included in the loaded moving image file, and determines a number of frames for generating attention areas. The processing for determining a number of frames of step S1702 will be described with reference to the flowchart of FIG. 17.

In step S1802, the control unit 112 extracts frame rate information from the header information of the processing target moving image file. Frame rate information represents, for instance, that the reproduction frame rate of the relevant moving image file is 29.97 (frames per second) or 30 fps. Next, in step S1803, the control unit 112 judges whether frame rate information has been extracted in step S1802. If frame rate information has been extracted, the process proceeds to step S1805. On the other hand, if frame rate information has not been extracted, the process proceeds to step S1804. In step S1804, the control unit 112 sets a tentative frame rate value to the moving image file. For the present embodiment, it is assumed that “15 fps” is set.

In step S1805, the control unit 112 determines a number of frames to be used for generating attention area information based on the acquired frame rate information. In the present invention, the number of frames over a moving image reproducing time of 5 seconds is to be used. For instance, if frame rate information is 30 fps, the number of processing target frames will be 150 (=5×30). However, if the frame rate value is a non-integer value, such as 29.97 fps, determination of a number of frames is performed after the frame rate value is rounded up to an integer value. The control unit 112 hands the information regarding the number of frames for generating attention areas determined as described above and the moving image file data to the image decoder unit 108, and concludes the series of operations shown in FIG. 17.

Returning now to FIG. 16, in step S1703, the image decoding unit 108 decodes one frame's worth of data from the file created by per-frame JPEG-compression processing, and passes the decoded data to the control unit 112. Next, in step S1704, the control unit 112 passes the data received from the image decoding unit 108 to the attention area detection processing unit 114. The attention area detection processing unit 114 judges whether a human figure exists in the moving image frame data. This judgment is similarly performed in the third embodiment by detecting the face of the human figure. Since the detection processing flow thereof is similar to that of the first embodiment (FIG. 6), a detailed description thereof will be omitted.

As a result of the face detection processing of step S1704, judgment is performed on whether a face exists within the processed moving image frame data. If a face exists, the process proceeds from step S1705 to S1706. If not, the process proceeds to step S1707. In step S1706, based on the processing results from the attention area detection processing unit 114, the control unit 112 stores the face detected area as an attention area information into the image storage unit 113. Information to be stored is a number of attention areas, coordinate values of central points of each attention area and radii of the circles. On the other hand, if it is judged that a face does not exist based on the processing results of the attention area detection processing unit 114, in step S1707, the control unit 112 stores a circular area such as that shown as reference numeral 804 in FIG. 8D, in other words, the central portion of the image, as attention area information to the image storage unit 113. Information to be stored is a number of attention areas, coordinate values of central points of each attention area and radii of the circles. After storing the information, the process proceeds to step S1708.

In step S1708, the image decoding unit 108 judges whether processing for the predetermined number of frames for which attention areas are to be generated has been concluded, based on information regarding the number of frames received from the control unit 112. If the processing has not been concluded, the process returns to step S1703. In this manner, the processing of the above-described steps S1703 to S1707 is repeated until attention area information is acquired for frames equivalent to the number of frames to be processed, determined in step S1702. In the event that processing for the predetermined number of frames has been concluded, the process proceeds from step S1708 to step S1709. In step S1709, the control unit 112 collectively stores the attention area information stored in steps S1706 and S1707. Information to be stored is a number of attention areas, coordinate values of central points of each attention area and radii of the circles. Once attention area information is stored in step S1709, the processing of FIG. 16 is concluded.

Returning now to FIG. 15, in step S1604, the control unit 112 reads out per-image attention area information stored in the image storage unit 113, and sorts the images according to the dimensions of attention areas based on radii information thereof.

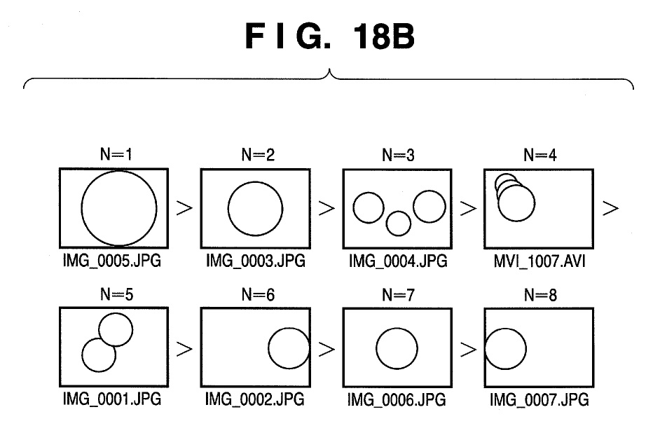

FIG. 18A shows an example of attention area information of eight images used for describing the third embodiment. Reference numerals 1901 and 1902 denote attention area information of the still image whose file name is IMG_{—}0001.JPG. Reference numeral 1903 denotes attention area information of the still image whose file name is IMG_{—}0002.JPG. The same holds for other images, and the circular shapes represent attention area information of each image. In addition, reference numerals 1904 to 1905 denote attention area information for each frame of the moving image whose file name is MVI_{—}1007.AVI. MVI_{—}1007.AVI is, for instance, a moving image with a total of 300 frames at a frame rate of 30 fps, and as described above, attention areas are acquired from images of 150 frames. Therefore, although 148 attention areas exist between attention areas 1904 and 1905, these attention areas are not shown for simplicity's sake. In the case of a moving image, a logical OR operation is performed on the per-frame attention area information between 1904 and 1905 to obtain a dimension of a single attention area.

In step S1604, attention area information of each image is sorted in descending order of their dimensions, as described earlier. Therefore, as shown in FIG. 18B, the eight images are sorted in descending order of the sizes of their attention areas, namely: IMG_{—}0005.JPG, IMG_{—}0003.JPG, IMG_{—}0004.JPG, MVI_{—}1007.AVI, IMG_{—}0001.JPG, . . . , IMG_{—}0007.JPG.

Next, in step S1605, the control unit 112 sets 1, which indicates a first image, to a variable N which indicates a processing sequence of layout target images. In the present embodiment, overlapping is arranged so that the greater the value of N, the further the image will be positioned towards the back. In addition, since processing will be performed in the descending order of attention area dimension, the layout target image at N=1 is IMG_{—}0005.JPG.

In step S1606, the control unit 112 determines a layout target image based on the value of the variable N which indicates a processing sequence of layout target images. In step S1607, the attention area information of the layout target image determined in step S1605 is acquired. In step S1608, the control unit 112 determines a position of the layout target images based on the acquired attention area information. The layout position determination method is arranged so that a position is selected where maximum exposure of the acquired attention area is achieved and at the same time non-attention areas are hidden as much as possible by images further towards the front.

In step S1609, the control unit 112 judges whether images further towards the front overlap the attention area of the layout target image. If an overlap is judged to exist, the process returns to step S1608. If it is judged that an overlap has not occurred, the process proceeds to step S1610. Therefore, step S1609 will be repeatedly executed until a layout is determined in which no images overlap with the attention area.

In step S1610, the control unit 112 judges whether there are images for which layouts for list display must be determined. If an image exists for which a layout for list display must be determined, the process proceeds to step S1611. In step S1611, the control unit 112 adds 1 to the variable N which indicates an image processing sequence, and the process returns to step S1606. In this manner, steps S1606 to S1609 are repeated until there are no more images for which layout processing must be performed.

When there are no more images for which layout processing must be performed, the process proceeds from step S1610 to S1612. In step S1612, the control unit 112 performs image list display on the image display unit 110 via the display composition unit 109. The present process is then terminated.

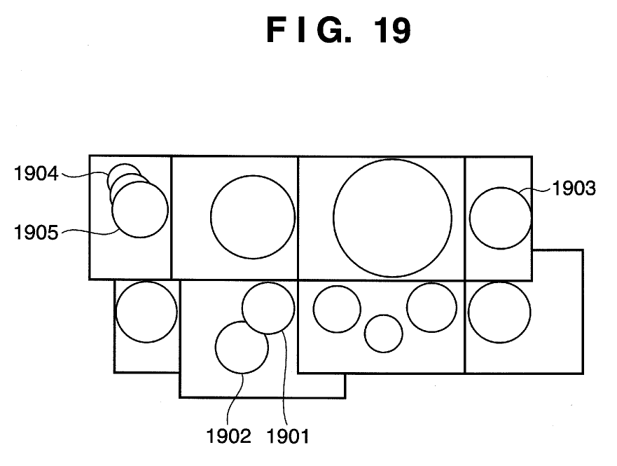

FIG. 19 is a diagram showing an example of overlapping list display which is displayed through executing the processing depicted by the flowchart shown in FIG. 15. It is shown that each image in FIG. 18S are displayed so that their attention areas do not overlap with other images. Incidentally, while an example displaying only eight images on a screen has been indicated in the above description for the sake of simplicity, it is needless to say that much larger quantities of images may be displayed instead.

[Update Function of Overlapping List Display]

As described above, in the third embodiment, attention areas of a moving image are acquired from five second's worth of frame images. Therefore, when the attention area changes shape or moves during reproduction after five seconds, it is possible that the attention area will enter an area that is hidden by other images. In this light, the image display apparatus 100 according to the third embodiment is equipped with a function to update layouts of images in a list display after performing image overlapping list display, based on attention area information which changes over elapsed time of reproducing of a moving image. The image list display update function will now be described with reference to the drawings.

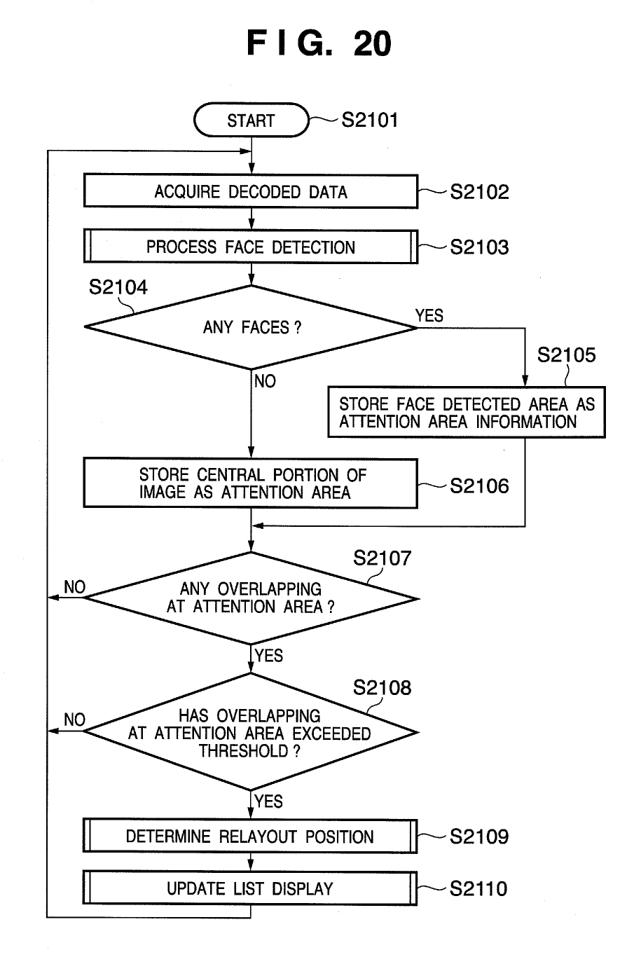

FIG. 20 is a diagram showing layout update processing for an overlapping list display of images according to the third embodiment. After conclusion of the overlapping list display processing of images described in FIG. 15, the control unit 112 initiates operations for layout update. The processing depicted in FIG. 20 is performed for all moving images in the overlapping list display.

In step S2102, the control unit 112 acquires decoded frame data from the image decoding unit 108. Next, through the processing of steps S2103 to S2106, if a face has been detected in the image data, the face detected area is set as the attention area. If a face has not been detected, the central portion of the image is set as the attention area. Since the processing of the steps S2103 to S2106 is similar to the processing in steps S1704 to S1707 in FIG. 16, a detailed description thereof will be omitted.

Next, in step S2107, judgment is performed on whether overlaps exist in the attention area. The attention area information stored in the foregoing step S2105 or S2106 is the attention area information of the moving image frame after a lapse of time since the determination of layout by the processing of FIG. 15. Therefore, depending on movements by the subject, it is possible that the attention area has changed, resulting in overlapping with surrounding images. In this light, the control unit 112 judges whether there are overlaps by the attention area of the moving image with its surrounding images, based on coordinate data of the current layout of the moving image and attention area information. If it is judged that no overlaps have occurred, the process returns to step S2102 to perform overlap judgment on the next moving image frame.

When an overlap by the attention area with surrounding images exists, the process proceeds from step S2107 to S2108. In step S2108, judgment is performed on whether the dimension of the overlapping portion of the attention area has exceeded a threshold. In other words, the control unit 112 judges whether the proportion of the number of pixels in the portion of the attention area which overlaps with other images in the number of pixels of the entire attention area has exceeded a certain threshold. If it is judged that the threshold has not been exceeded, the process returns to step S2102 and overlap judgment is performed on the next moving image frame. When the proportion of the number of pixels in the portion of the attention area which overlaps with other images in the number of pixels of the entire attention area has exceeded a certain threshold, the process proceeds from step S2108 to S2109.

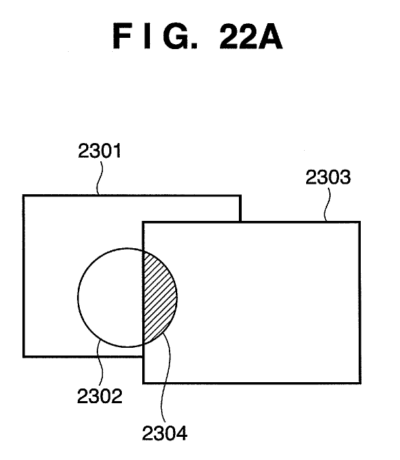

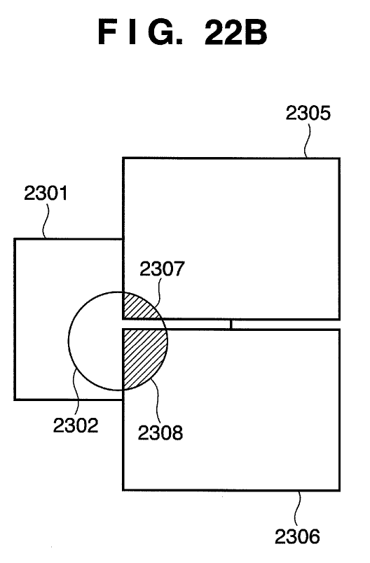

FIGS. 22A and 22B are pattern diagrams showing relationships between an arrangement of images newly overlapped as a result of changes in attention area information of a moving image, and attention areas. FIG. 22A shows an example in which an overlap with a single image has occurred as a result of changes in attention area information of a moving image. FIG. 22B shows an example in which overlaps with two images have occurred as a result of changes in attention area information of a moving image. In FIG. 22A, reference numeral 2301 denotes a moving image in which an attention area has changed due to elapsed time of reproducing, while 2302 denotes the attention area that has changed due to elapsed time of reproducing of the moving image 2301, and 2303 denotes an image laid out to overlap with the moving image 2301. FIG. 22A shows an occurrence of an overlap with image 2303 due to a change in the attention area 2302 of the moving image 2301. The overlapping portion is represented by reference numeral 2304. In addition, in FIG. 22B, like reference numerals to FIG. 22A indicate like parts. In FIG. 22B, images 2305 and 2306 are images laid out to overlap with the moving image 2301. It is shown that, due to a change of the attention area 2302 of the moving image 2301, overlaps have occurred between the attention area and the images 2305 and 2306. The overlapping portions are represented by reference numerals 2307 and 2308.

In the third embodiment, the threshold used in step S2108 is assumed to be 15%. In the example shown in FIG. 22A, when the number of pixels in the overlapping portion 2304 of the attention area 2302 exceeds 15% of the total number of pixels in attention area 2302, the process proceeds to step S2109. In the example shown in FIG. 22B, when the sum of the number of pixels in the overlapping portions 2307 and 2308 of the attention area exceeds 15% of the total number of pixels in attention area 2302, the process proceeds to step S2109. Cases where there are three or more overlapping images are treated similarly. That is, the process proceeds to step S2109 when a sum of the number of pixels of the overlapping portions of the attention area exceeds 15% of the total number of pixels in the attention area.

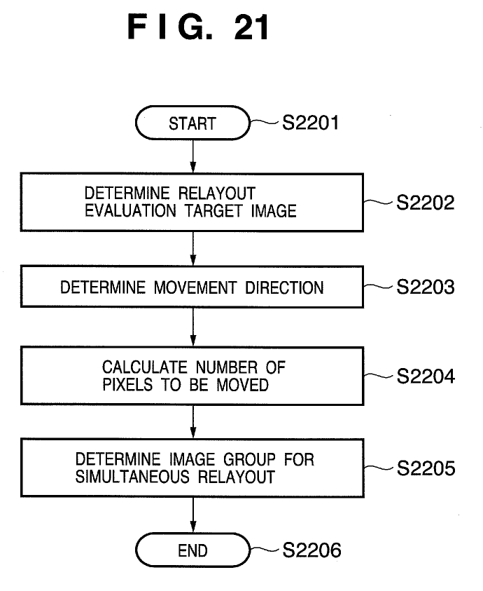

Returning now to FIG. 20, in step S2109, the control unit 112 determines a relayout position of the moving image. Relayout processing performed for an overlapping image list, where an overlap with another image occurs as a result of a change in the attention area information of a moving image, will now be described with reference to the drawings. FIG. 21 is a flowchart depicting processing for determining a relayout position in step S2109.

In step S2202, the control unit 112 determines a relayout evaluation target image for determining a movement direction and a number of pixels to be moved when performing relayout, based on the number of images for which overlaps have occurred and the number of pixels of the overlapping portion of attention area and image, due to changes in attention area information of a moving image. When there is one overlapping image, as shown in FIG. 22A, the control unit 112 deems that image to be the relayout evaluation target image. When there are two overlapping images, as shown in FIG. 22B, the image having a larger number of pixels in its overlapping portion is deemed to be the relayout evaluation target image. In the case of FIG. 22B, since the number of pixels in the overlapping portion 2308 of the image 2306 is larger than the number of pixels in the overlapping portion 2307 of the image 2305, image 2306 is deemed to be the relayout evaluation target image. Similarly, in a case where there are three or more overlapping images, the image with the most number of pixels in its overlapping portion is deemed to be the relayout evaluation target image. In the event that the numbers of overlapping pixels are the same, the image for which a layout was determined first in the flowchart of FIG. 15, or in other words, the image with the smallest N value is deemed to be the relayout evaluation target image.

Next, in step S2203, the control unit 112 determines a movement direction of the relayout evaluation target image determined in the previous step S2202 based on the current layout of the relayout evaluation target image and attention area information which indicates an attention area after change.

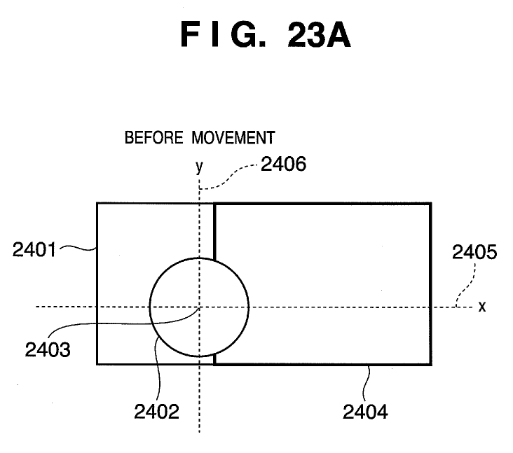

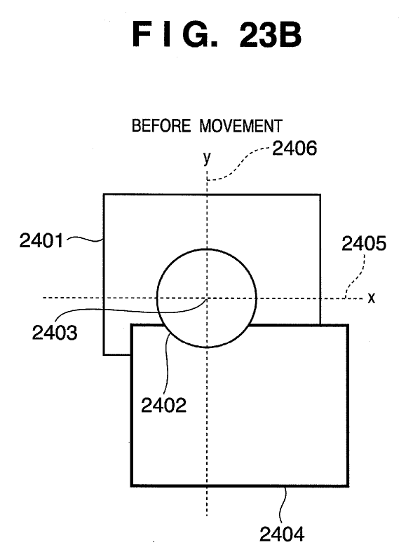

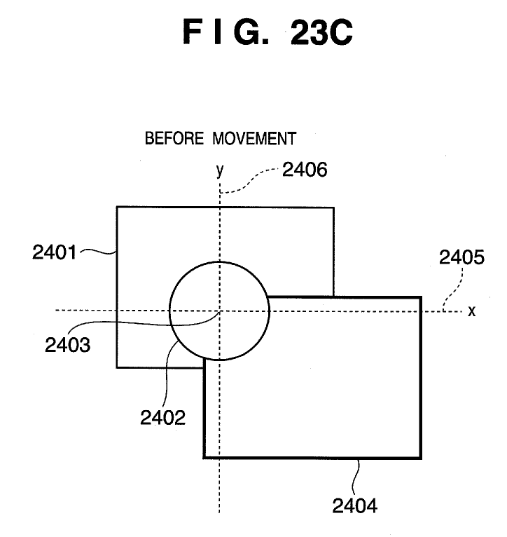

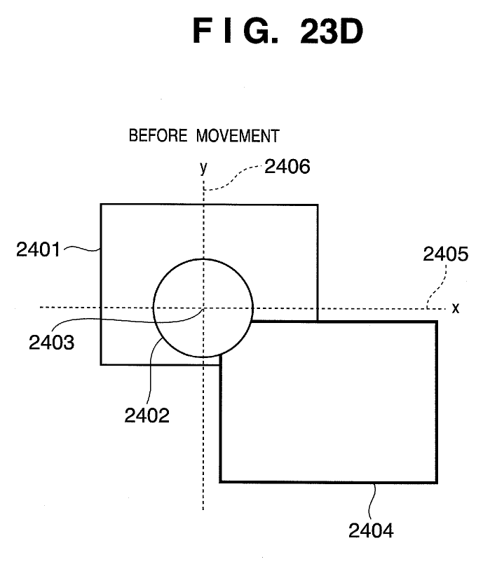

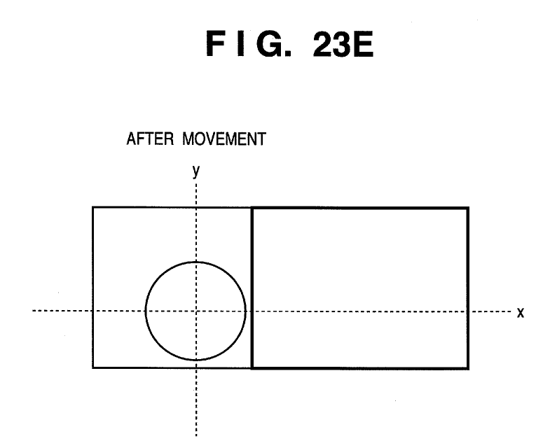

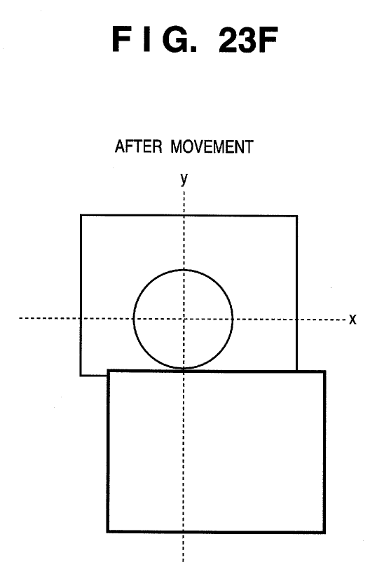

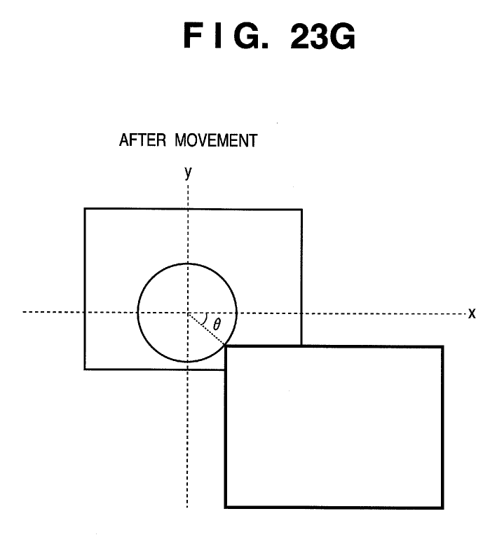

FIGS. 23A to 23G are diagrams typically showing an example of operations for performing relayout. FIGS. 23A to 23D show four patterns as example of overlaps which occur due to changes in attention area information.

In FIG. 23A, reference numeral 2401 denotes a moving image in which an attention area has changed due to elapsed time of reproducing, while 2402 denotes the attention area that has changed due to elapsed time of reproducing of the moving image 2401, and 2403 denotes a central point of the attention area 2402. In addition, reference numeral 2404 denotes an image laid out so that a portion thereof overlaps with the moving image 2401, which is an image for which an overlap has occurred with the attention area 2402 after change.

First, the control unit 112 sets a virtual axis x (2405) and a virtual axis y (2406) which intersect at the central point 2403 of the attention area 2402, in order to determine a direction in which the image is to be moved. The virtual axis x is deemed to be parallel to the long side of the moving image 2401, while the virtual axis y is deemed to be parallel to the short side of the moving image 2401.

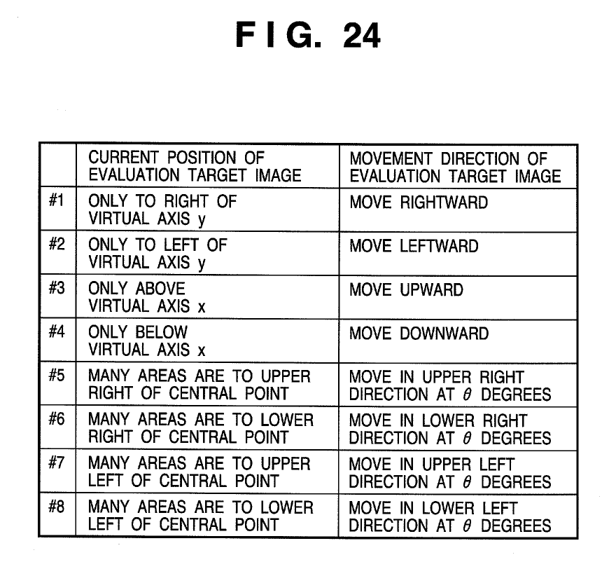

Next, the control unit 112 determines a movement direction of the image 2404 based on the direction of the layout of the image 2404 in relation to the virtual axis x (2405) and the virtual axis y (2406). In the present embodiment, movement direction is determined from the eight layout patterns (#1 to #8) as shown in FIG. 24.

For instance, in the case of FIG. 23A, since the image 2404 only exists on the right side of the virtual axis y (2406), the movement direction is determined to be rightward (corresponding to #1 in FIG. 24). After movement, the layout will be as shown in FIG. 23E.

Similarly, in the case of FIG. 23B, since the image 2404 only exists on the lower side of the virtual axis x (2405), the movement direction is determined to be downward (corresponding to #2 in FIG. 24). After movement, the layout will be as shown in FIG. 23F.

Similarly, in the case of FIG. 23C, a larger portion of the image 2404 exists in the right of the virtual axis y (2406) and below the virtual axis x (2405). In other words, a large portion of the image is positioned towards the bottom right of the central point. Therefore, the movement direction is determined to be a lower right direction θ (corresponding to #6 in FIG. 24). After movement, as in the case of FIG. 23G, the layout will be as shown in FIG. 23G. In this example, θ is assumed to be 45 degrees.

Similarly, in the case of FIG. 23D, the image only exists to the right of the virtual axis y (2506) and below the virtual axis x (2505). Therefore, movement direction is determined to be a lower right direction θ (corresponding to 46 in FIG. 24). After movement, in a manner similar to the case of FIG. 23C, the layout will be as shown in FIG. 23G.

Returning now to FIG. 21, in step S2204, the control unit 112 determines a movement amount which ensures that the attention area and the relayout evaluation target image do not overlap in the event that the image is moved in the movement direction determined in the previous step S2203. For the present embodiment, movement amount is defined as the number of pixels to be moved vertically and horizontally.

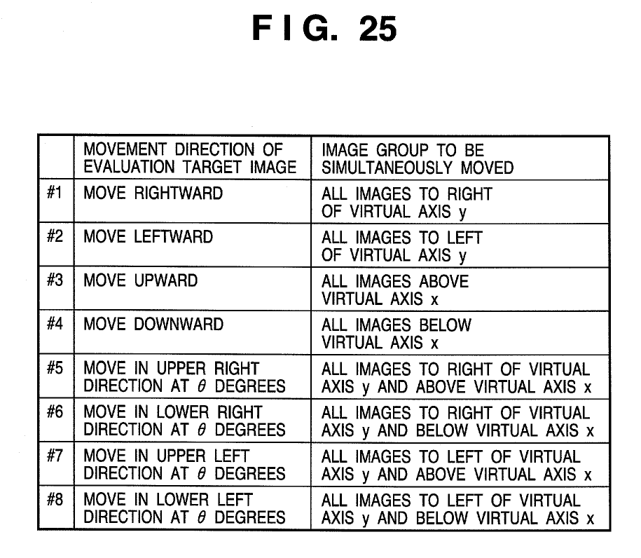

Next, in step S2205, the control unit 112 determines an image group to be moved simultaneously with the relayout evaluation target image determined in step S2202, based on the movement direction information determined in step S2203. In the third embodiment, the image group is determined from the eight layout patterns (#1 to #8) as shown in FIG. 25. For instance, when the movement direction of the evaluation target image is rightward (#1), all images located to the right of the virtual axis y are selected as the image group to be simultaneously moved. In addition, when the movement direction of the evaluation target image is downward (#4), all images located below the virtual axis x are selected as the image group to be simultaneously moved.

In the above manner, after a relayout evaluation target image to be re-laid out, a movement direction and movement amount thereof have been determined in step S2109 (S2202 to S2205 in FIG. 21), the process proceeds to step S2110.

In step S2110, the control unit 112 performs processing for updating the image overlapping list display on the image display unit 110 via the display composition unit 109.

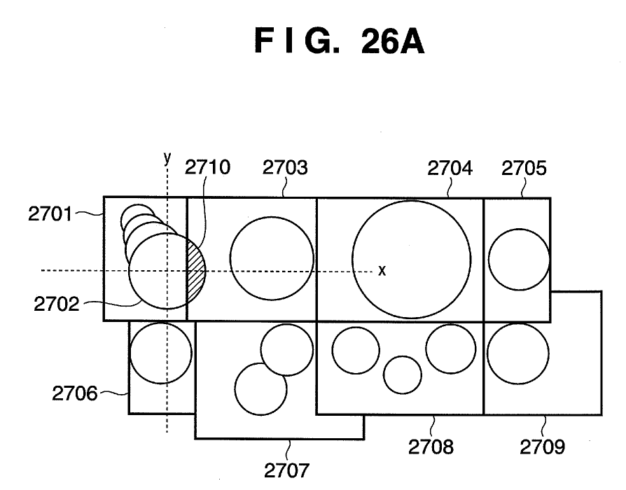

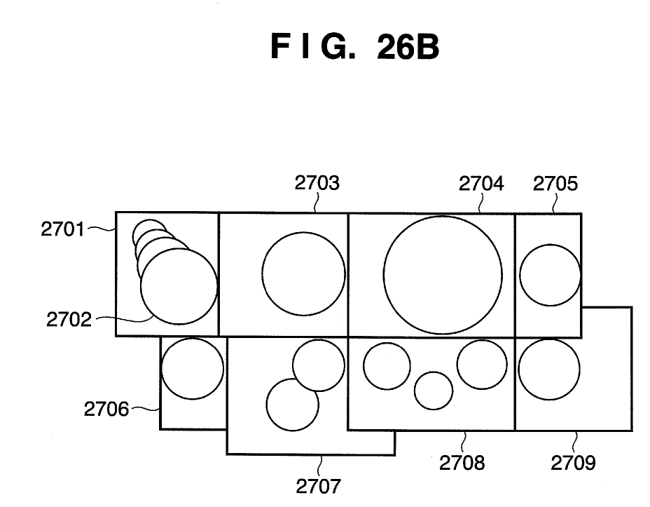

FIGS. 26A and 26B show examples of list displays in a case where an image group is moved from a state of overlapping image display of FIG. 19 using the image list display update function shown in FIG. 20. In FIG. 26A, the attention area of the moving image 2701 has moved due to elapsed time of reproducing and has become attention area 2702. As a result, a portion thereof is overlapping with image 2703. Reference numerals 2703 to 2709 denote still images, while reference numeral 2710 represents the overlapping portion of the attention area 2702 and the still image 2703. In the display state of FIG. 26A, still image 2703 is first determined as a relayout evaluation target image. Since the still image 2703 exists only to the right side of the virtual axis y, its movement direction will be rightward. In addition, since this case corresponds to #1 of FIGS. 24 and 25, it will be determined that all images to the right side of the virtual axis y (all images in which portions thereof exists to the right of the virtual axis y) will be moved rightward. Therefore, still images 2703 to 2709 are all moved rightward, thereby updated to a list display as shown in FIG. 26B. In the above description, the virtual axes x and y are set so that the axes intersect at the center of an attention area in which an occurrence of overlapping has been detected (most recently detected attention area).

As seen, according to the third embodiment, an image input device is connected to an image display apparatus, and based on user instructions, image data is acquired from the image input device and attention area information is generated for the image data. In addition, during generation of attention area information for a moving image, a number of frames for generating attention areas is determined based on the frame rate information of the moving image. Furthermore, after image overlapping list display, relayout of the overlapping list display is arranged to be performed based on attention area information which changes due to elapsed time of reproducing of the moving image. Therefore, contents of images may be verified even when attention area information moves as a result of elapsed time of reproducing moving images.

### Fourth Embodiment

A fourth embodiment will now be described.

In the fourth embodiment, storing of images and generating of attention area information are automatically performed when the user connects a memory card or a digital camera, and overlapping image display is performed. In addition, processing for suspending generating operations of attention area information is added in the event that the proportion of the number of pixels in an attention area generated by performing logical OR on attention areas in the frames of the moving image exceeds a certain threshold during the generation of attention area information.

The configuration of an image display apparatus to which the fourth embodiment is applied is similar to each embodiment described earlier (FIG. 1). Attention area generation processing for moving images according to the fourth embodiment will now be described.

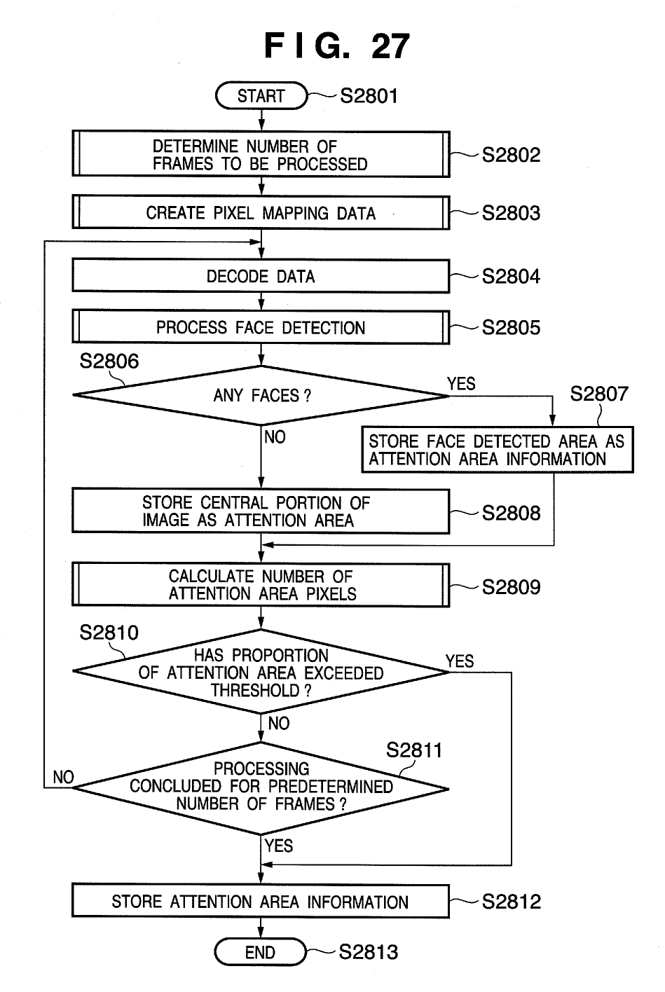

FIG. 27 is a flowchart showing generation processing of attention area information of a moving image according to the fourth embodiment. The present processing is performed in place of the processing of the third embodiment shown in FIG. 16.

In step S2802, the control unit 112 acquires information regarding a frame rate used during moving image reproduction from header information included in the loaded moving image file, and determines a number of frames for generating attention areas. This processing for determining a number of frames is as described in the third embodiment (FIG. 17).

Next, in step S2803, the control unit 112 acquires frame size information for moving image reproduction from header information contained in the loaded moving image file, and creates array data (hereinafter described as pixel mapping data) capable of storing per-pixel binary information. Frame size information is acquired on a per-pixel basis for each horizontal and vertical size. Initial values of image mapping data will be set to 0 for all pixels.

In step S2804, the image decoding unit 108 decodes one frame's worth of data from the file created by per-frame JPEG-compression processing, and passes the decoded data to the control unit 112. In step S2805, the control unit 112 passes the data received from the image decoding unit 108 to the attention area detection processing unit 114. The attention area detection processing unit 114 judges whether a human figure exists in the moving image frame data. This judgment is similarly performed in the fourth embodiment by detecting the face of the human figure. Thus, since the detection processing is similar to those of the first to third embodiments (FIG. 6), a description thereof will be omitted. Based on the processing results of the attention area detection processing unit 114, if it is judged that a face exists in the processed moving image frame data, the process proceeds from step S2806 to S2807. If not, the process proceeds from S2806 to S2808.

In step S2807, based on the processing results from the attention area detection processing unit 114, the control unit 112 stores the face detected area as attention area information into the image storage unit 113. Information to be stored is a number of attention areas, coordinate values of central points of each attention area and radii of the circles. After storing the attention area information, the process proceeds to step S2809. On the other hand, in step S2808, as shown by reference numeral 804 in FIG. 8D, the control unit 112 stores attention area information which indicates the central portion of the image as attention area in the image storage unit 113. Information to be stored is a number of attention areas, coordinate values of central points of each attention area and radii of the circles. After storing the attention area information, the process proceeds to step S2809.

In step S2809, the control unit 112 first changes the value of image mapping data based on the central point coordinate values and the radius of the circle of the attention area information generated in the previous steps S2807 or S2808. In other words, the pixel value of the portion corresponding to the newly acquired attention area is set to 1. The pixel value will be left as-is if the original value is 1. The number of pixels with values of 1 is counted and is deemed the number of attention area pixels of the relevant image.

In step S2810, the control unit 112 judges whether the proportion of the number of attention area pixels counted in step S2809 in the total number of pixels in the frames of the relevant moving image has exceeded a certain threshold. If the threshold has been exceeded, the process proceeds to step S2812, while if not, the process proceeds to step S2811.

For the fourth embodiment, the threshold has been set at 50%. For instance, if the frame of the moving image has a horizontal size of 640 pixels and a vertical size of 480 pixels, the process proceeds to step S2812 when the number of attention area pixels exceeds 153,600 (=640×480×0.5).

In step S2811, the image decoding unit 108 judges whether processing for the predetermined number of frames for which attention areas are to be generated has been concluded, based on information regarding the number of frames for generating attention areas received from the control unit 112. If the processing has not been concluded, the process proceeds to step S2804. If the processing has been concluded, the process proceeds to step S2812. In step S2812, attention area information temporarily stored in the previous steps S2807 and S2808 are collectively stored in the image storage unit 113. Information to be stored is a number of attention areas, coordinate values of central points of each attention area and radii of the circles. After the information is stored, the control unit 112 temporarily suspends generating operations of attention area information of the moving image. As seen, according to the processing of FIG. 27, generating operations for attention areas are temporarily suspended either in the event that determination of attention areas have been concluded for the number of frames to be processed which is set according to the frame rate, or in the event that the dimension of the area set as an attention area exceeds a certain proportion of the relevant image.

After temporal suspension of the generating operations for moving image attention area information, image overlapping list display is performed according to the flow depicted in FIG. 27 in a manner similar to the above-described third embodiment. Furthermore, layout of images in the list display is updated based on attention area information which changes according to elapsed time of reproducing moving images in a manner similar to the third embodiment. Therefore, contents of moving images may be verified even when attention area information moves as a result of elapsed time of reproducing moving images.

Moreover, for the fourth embodiment, generating of attention area information of moving images is executed either until the number of frames to be processed which is set according to the frame rate information of the moving image is reached, or until the proportion of the number of pixels in the attention area in the total number of pixels in the frame of the moving image exceeds a certain threshold. Therefore, when compared with the third embodiment, generation of attention area information prior to overlapping list display of images may be quickly concluded, and overlapping list display of images may be quickly displayed.

In the fourth embodiment, detection of attention areas of moving images either when (a) the dimension of the attention area exceeds a certain proportion, or when (b) extraction of attention areas have been concluded for a predetermined number of frames, whichever comes first. However, as for the condition (b), the conditions of the first embodiment or the second embodiment may be applied instead. In other words, condition (b) may be replaced by either “when extraction of attention areas have been concluded for all frames” or “when extraction of attention areas have been concluded for frames selected at a predetermined distance from the entire moving image”.

As seen, according to the second to fourth embodiments, attention area information is not generated from all frames, but is generated from thinned out frames, or arranged to terminate when the dimension of the attention area reaches or exceeds a certain size. Therefore, the processing speed for efficiently performing layout of a plurality of images including moving images on the screen may be increased.

### Fifth Embodiment

A fifth embodiment will now be described.

In the fifth embodiment, overlapping list display of images is automatically performed upon connection of a memory card or a digital camera by the user. After list display, layout of a moving image whose attention area has changed due to elapsed time of reproducing is moved to the forefront to be displayed. The present embodiment is particularly effective when there is a plurality of moving images to be list-displayed.

An image display apparatus 100 according to the fifth embodiment is as shown in FIG. 1. In addition, images used in the fifth embodiment are similar to those used in the first to fourth embodiments, and are still images and moving images photographed by a DSC. For the fifth embodiment, it is assumed that still images do not possess face areas and do not contain focus position information in their Exif header information.

[Image Overlapping List Display Function of Image Display Apparatus]

Overlapping list display of images according to the fifth embodiment will now be described. Overlapping list display of images by the image display apparatus 100 according to the fifth embodiment is initiated when the user connects an image input device 118 to the image display apparatus 100.

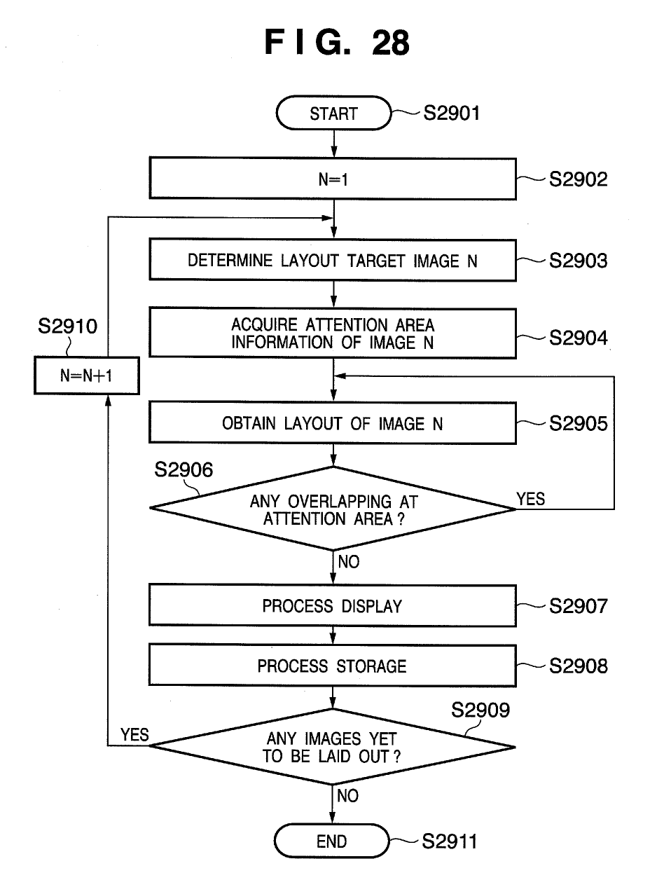

FIG. 28 is a flowchart which depicts processing for overlapping list display of images mainly through operations of the control unit 112. The operations depicted by the flowchart of FIG. 28 will now be described. When the user connects the image input device 118 to the image display apparatus 100, the control unit 112 receives a device connection detection event from the image input unit 107, and commences operations.

In step S2902, control unit 112 sets 1, which indicates a first image, to a variable N which indicates a processing sequence of layout target images. In the present embodiment, overlapping is arranged so that the greater the value of N, the further the image will be positioned towards the back. For the present embodiment, it is assumed that the processing will be performed in a sequence of file names of images.

In step S2903, a layout target image is determined based on the value of the variable N which indicates a processing sequence of layout target images. The image determined as the layout target is loaded into the temporary storage unit 115 from the image input device 118. In step S2904, the attention area information of the image determined in step S2903 is acquired. However, if attention area information of the image has not been generated, the central portion of the image will be deemed attention area information, as indicated by reference numeral 804 of FIG. 8D.

Next, in step S2905, the control unit 112 determines a layout position of the layout target image, designated by the variable N, based on attention area information. The layout position determination method is arranged so that a position is selected where maximum exposure of the acquired attention area is achieved and at the same time non-attention areas are hidden as much as possible by images further towards the front.

In step S2906, the control unit 112 judges whether images further towards the front overlap the attention area of the layout target image N. If it is judged that an image further towards the front is overlapping the attention area, the process returns to step S2905. If not, the process proceeds to step S2907. Therefore, the processing of steps S2905 and S2906 will be repeatedly performed until a layout without any overlapping is determined.

Next, in step S2907, the control unit 112 displays the image for which a layout has been determined onto the image display unit 110 via the display composition unit 109. If the image is a still image, a thumbnail image is readout and decoded by the image decoding unit 108 to be displayed. In the case of a moving image, the first frame data of the moving image is decoded by the image decoding unit 108, and the size is modified to be displayed. In step S2908, the control unit 112 stores the image on which display processing was performed and its attention area information into the image storage unit 113. Subsequently, in step S2909, the control unit 112 judges whether images to be list-displayed exist for which layout processing have not yet been performed. If such an image exists, the process proceeds to step S2910, where the control unit 112 adds 1 to the variable N which represents a processing sequence of images. On the other hand, if there are no images to be list-displayed for which layout processing has not yet been performed, the present process terminates in step S2909. In this manner, steps S2903 to S2908 are repeated until there are no more images for which layout processing must be performed.

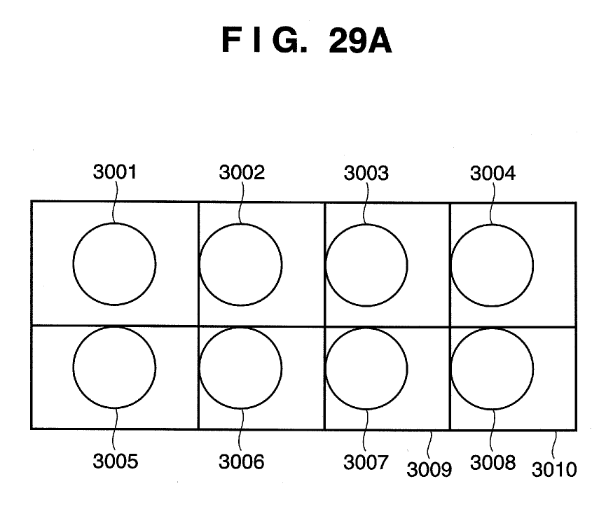

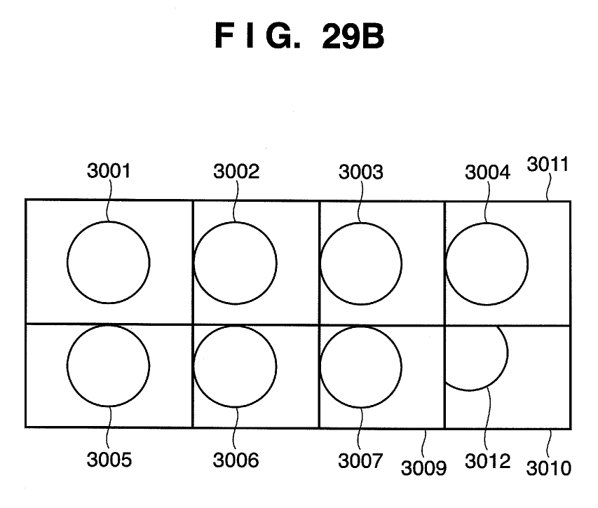

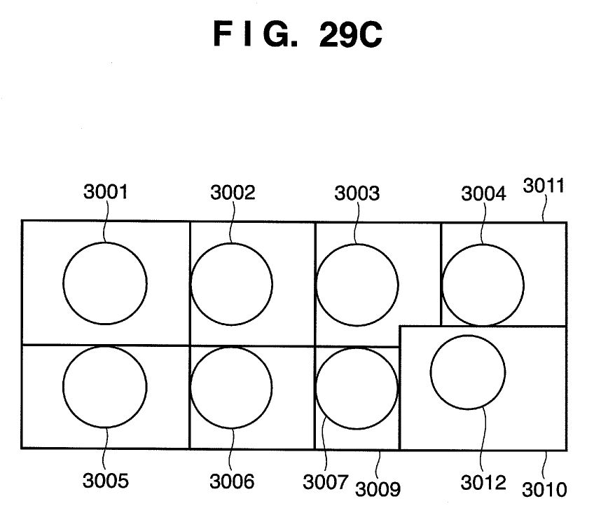

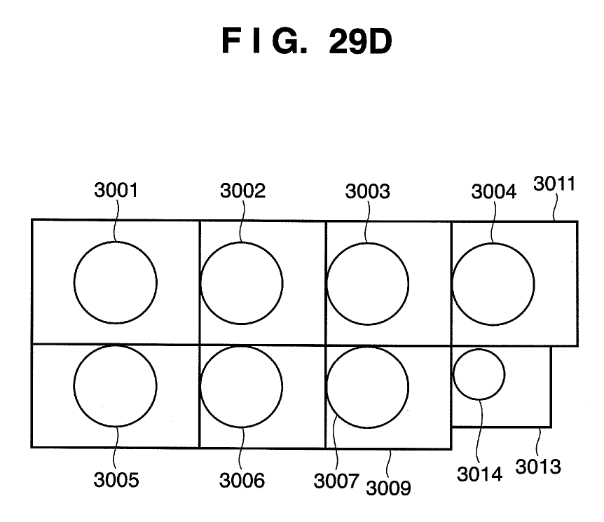

FIG. 29A is an example of overlapping list display of images displayed after executing the processing depicted in the flowchart of FIG. 28. The respective attention areas of the images are indicated by reference numerals 3001 to 3008. Upon conclusion of overlapping image display, the control unit 112 initiates generation of attention areas of images. Generation of attention areas of images cooperatively performed by the control unit 112, the image decoding unit 108 and the attention area detection processing unit 114, and operations in a case where attention areas change as a result of elapsed time of reproducing, will now be described with reference to the drawings. For the present embodiment, update processing of overlapping list display will be described using an example in which image 3010 of FIG. 29A, which is a moving image, changes as a result of elapsed time of reproducing.

FIG. 30 is a flowchart depicting attention area generating and operations in a case where attention areas change due to elapsed time of reproducing. In step S3102, the control unit 112 acquires decoded frame data from the image decoding unit 108. The processing of steps S3103 to S3107 in FIG. 30 is similar to the processing of steps S2103 to S2107 in FIG. 20.

In step S3107, when it is judged that the attention area has an overlap, the process proceeds to step S3108. In step S3108, the control unit 112 judges whether a plurality of moving images exist in the list-displayed images. If a plurality of moving images exist, the process proceeds to step S3109. If there is only one moving image, the process proceeds to step S3110. Since the processing of steps S3110 to S3112 is similar to the steps S2108 to S2110 of FIG. 20, a description thereof will be omitted.

In step S3109, the control unit 112 determines a relayout position so that the moving image, on which the overlap with another image has occurred, is moved to the forefront, and updates display. For instance, a description will be provided using as an example a case where an attention area 3008 has changed from a list display state of FIG. 29A to an attention area 3012, shown in FIG. 29B, as a result of elapsed time of reproducing of a moving image 3010. In FIG. 29B, the attention area 3012 of the moving image 3010 is overlapped by the images 3009 and 3011. In such a case, through the processing of step S3109, layout is performed so that the moving image 3010 comes to the forefront as shown in FIG. 29C.

As seen, according to the fifth embodiment, an image input device is connected to an image display apparatus, and based on user instructions, image data is acquired from the image input device and attention area information is generated for the image data after performing list display of images. In addition, when overlapping occurs with the attention area information of a moving image and another image as a result of a change in attention area information due to elapsed time of reproducing moving images, judgment is performed on whether a plurality of moving images are included in the list display. When a plurality of moving images is included, the relevant moving image is arranged to be moved to the forefront. Therefore, contents of moving images may be verified even when attention area information moves as a result of elapsed time of reproducing moving images.

Incidentally, a limitation may be imposed so that relayout of other moving images may not be performed to the front of a moving image which has already been moved to the forefront. By imposing such limitations, it is also possible to prevent occurrences of problems where identification of the contents of moving images becomes difficult due to frequent interchanging of layout among moving images.

### Sixth Embodiment

A sixth embodiment will now be described. In the fifth embodiment, when a change in an attention area of a moving image caused the attention area to overlap with other images, the entire attention area was arranged to be displayed by displaying the relevant moving image in the forefront. With the sixth embodiment, a display size of a moving image will be changed so that the attention area does not overlap with other images. The sixth embodiment is particularly effective when there is a plurality of moving images to be list-displayed.

The configuration of an image display apparatus according to the sixth embodiment is similar that of the fifth embodiment. In addition, images used in the sixth embodiment are similar to those used in the first to fifth embodiments, and are still images and moving image photographed by a DSC. For the sixth embodiment, it is assumed that still images do not possess face areas and do not contain focus position information in their Exif header information, as was provided for the fifth embodiment.

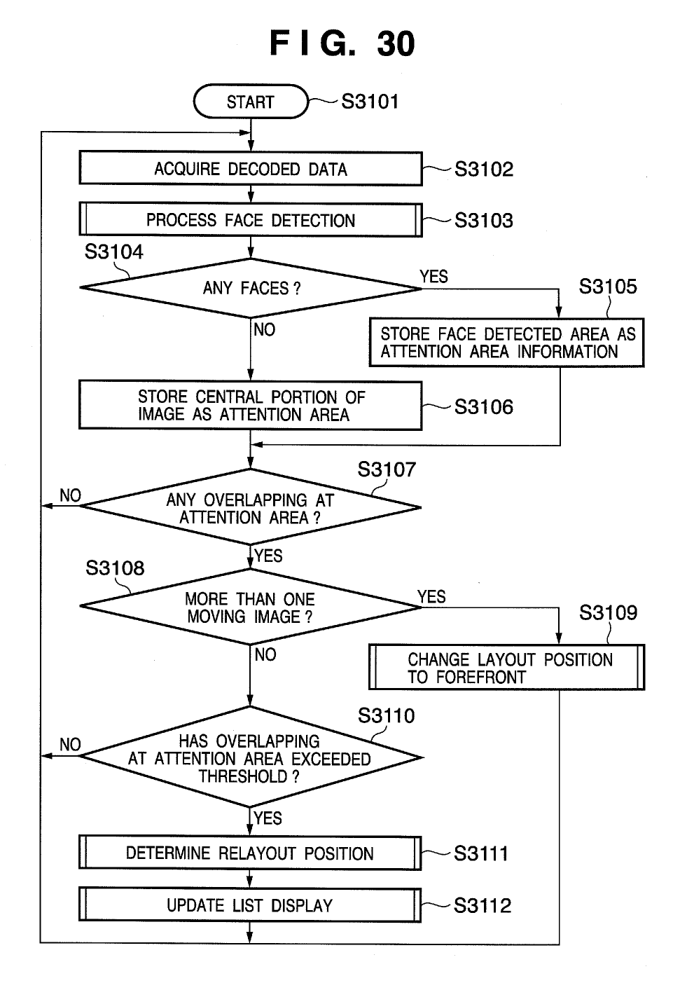

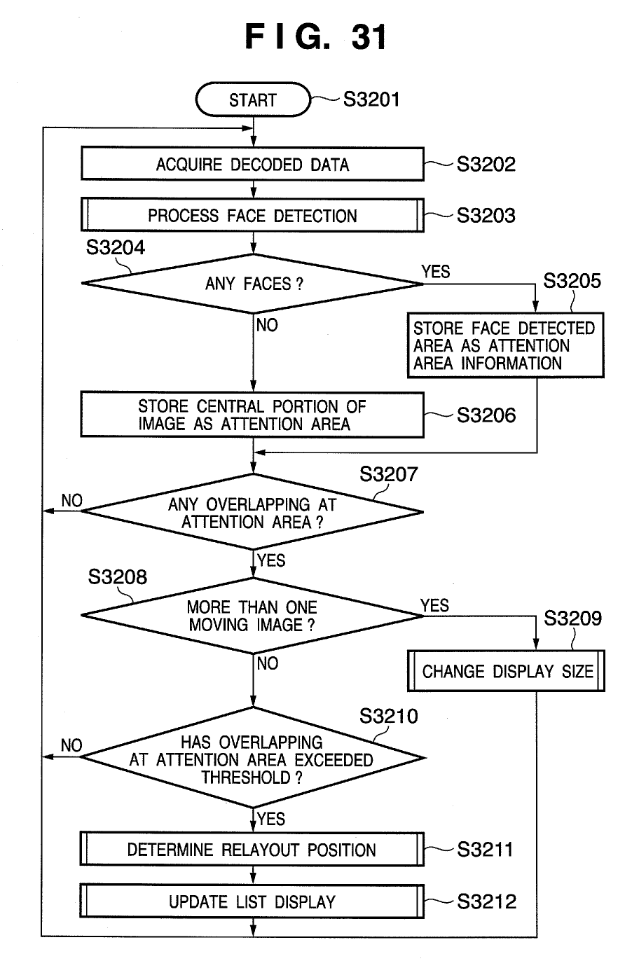

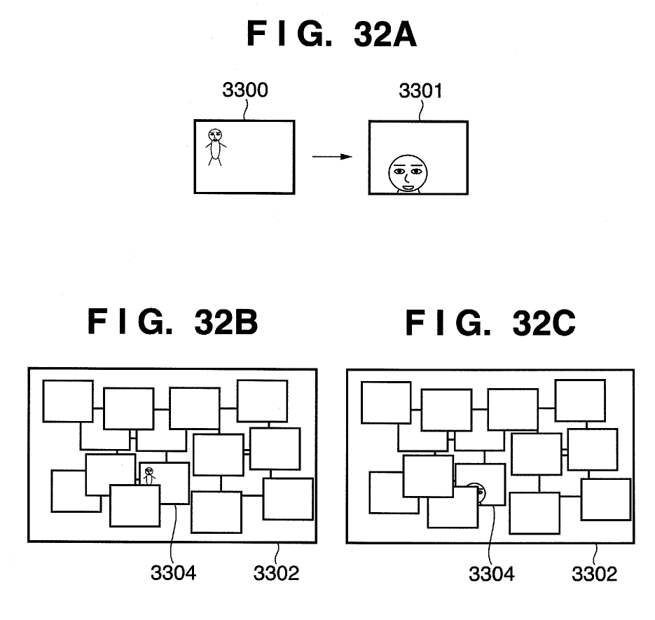

FIG. 31 is a flowchart depicting attention area generating for each list-displayed moving image and list display update processing in a case where attention areas change due to elapsed time of reproducing. Since the respective operations performed in steps S3202 to S3208 and in steps S3210 to S3212 are similar to the operations performed in steps S3102 to S3108 and in steps S3110 to S3112 of FIG. 30, descriptions thereof will be omitted.

In step S3209, the control unit 112 determines a size so that the moving image, on which the overlap with another image has occurred, does not overlap with the other image, and changes the size of the moving image. For instance, in the case where the attention area changes due to elapsed time of reproducing the moving image 3010, as shown in FIG. 29B, overlaps occur at the changed attention area 3012 of the moving image 3010 with the images 3009 and 3011. In such a case, as shown in FIG. 29D, the size of the moving image 3010 of FIG. 29B is changed to that of moving image 3013 so that the attention area 3014 does not overlap with other images, and display is updated. In the sixth embodiment, size is determined in a state where the coordinates of the central portion of the image 3010 of FIG. 29B is congruent to the coordinates of the central point of the image 3013 of FIG. 29D, so that the attention area does not overlap with other images.

As seen, according to the sixth embodiment, an image input device is connected to an image display apparatus, and based on user instructions, image data is acquired from the image input device and attention area information is generated for the image data after performing list display of images. In addition, when overlapping occurs with the attention area information of a moving image and another image as a result of a change in attention area information due to elapsed time of reproducing moving images, judgment is performed on whether a plurality of moving images are included in the list display. When a plurality of moving images is included, the size of the moving images are arranged to be changed. Therefore, it is now possible to verify contents of moving images even when attention area information moves as a result of elapsed time of reproducing moving images.

### Seventh Embodiment

A seventh embodiment will now be described. In the previous embodiments, for a case where attention area information changes due to elapsed time of reproducing of a moving image, resulting in an overlap with other images, descriptions were respectively provided for an example in which surrounding images were moved, for an example in which the overlapped moving image was moved to the forefront, and for an example in which the size of the moving image was changed. In the seventh embodiment, for a case where attention area information changes due to elapsed time of reproducing of a moving image, resulting in an overlap with other images, a description will be provided for an example of control which does not involve moving images, changing hierarchical relations or sizes thereof.

When attention area information changes due to elapsed time of reproducing of a moving image, resulting in an overlap with other images, the control unit 112 controls the image decoding unit 108 to suspend reproduction of the moving image at which the overlap has occurred and resume reproduction from the start of the moving image. For instance, processing to resume reproduction of the moving image from the start thereof may be arranged to be executed in step S2109 (FIG. 20). Using this control, it is possible to repeatedly reproduce only the time portion during which the attention area portion is exposed over the overlapping list display. Therefore, it is now possible for a user to verify contents of moving images even when overlapping list display is performed.

In addition, the control unit 112 stores attention area information of the moving image at the time of occurrence of the overlap. When next performing overlapping list display, layout is determined using the stored attention area information. This enables even attention area portions, in which an overlap had previously occurred, to be exposed and displayed. By repeating the above operation several times, a layout where attention areas of a moving image are entirely exposed may be achieved when performing overlapping list display.

### Other Embodiments

In the above-described embodiments of the present invention, descriptions were provided in which a group of images, JPEG-compressed on a per-frame basis, was used as an example of moving image data. However, encoding methods are not limited to the above, and the present invention may be applied to data encoded by encoding methods capable of decoding one frame's worth of data, such as MPEG1, MPEG2 and MPEG4.

Additionally, in each of the above-described embodiments, generating of attention area information may be arranged to be executed while the image display apparatus is receiving television broadcasting and a user is watching a TV program, which is a basic function of the image display apparatus according to the present invention.

Furthermore, while a television receiver has been used as an example of the image display apparatus 100 in the above-described embodiments, the present invention is not limited to this example. It is obvious that the present invention may be applied to a display device of a general purpose computer such as a personal computer.

Thus, the object of the present invention may be achieved by realizing any of the portions of the illustrated function blocks and operations by a hardware circuit or by software processing using a computer.

In other words, the present invention includes cases where the functions of the above-described embodiments are achieved by directly or remotely supplying a software program to a system or an apparatus, and having the system or apparatus read out and execute the supplied program codes. In these cases, the program to be supplied is a program corresponding to the flowcharts indicated in the drawings in the embodiments.

Therefore, the program codes themselves, to be installed to a computer to enable the computer to achieve the functions and processing of the present invention, may also implement the present invention. In other words, the computer program itself for implementing the functions and processing of the present invention are also encompassed in the present invention.

In such cases, as long as program functions are retained, the program may take such forms as an object code, an interpreter-executable program, or script data supplied to an OS.

Storage devices for supplying the program may include, for instance, a floppy disk (registered trademark), a hard disk, an optical dick, a magneto-optical disk, an MO, a CD-ROM, a CD-R, a CD-RW, a magnetic tape, a nonvolatile memory card, a ROM, a DVD (DVD-ROM, DVD-R) or the like.

Other methods for supplying the program may include cases where a browser of a client computer is used to connect to an Internet home page to download the computer program of the present invention from the home page into a storage media such as a hard disk. In these cases, the downloaded program may be a compressed file containing an auto-install function. In addition, the present invention may also be achieved by dividing the program codes which configure the program of the present invention into a plurality of files, and downloading each file from a different home page. In other words, a WWW server which allows downloading of program files for achieving the functions and processing of the present invention on a computer by a plurality of users is also included in the present invention.

In addition, the present invention may take the form of encoding the program of the present invention and storing the encoded program in a storage media such as a CD-ROM to be distributed to users. In this case, it is also possible to have users who satisfy certain conditions download key information for decoding from a home page via the Internet, and use the key information to execute the encoded program for installation on a computer.

Furthermore, the functions of the above-described embodiments may be achieved by either having a computer execute a read out program, or through collaboration with an OS and the like running on the computer according to instructions from the program. In such cases, the functions of the above-described embodiments are achieved by processing performed by the OS or the like, which partially or entirely performs the actual processing.

Moreover, all of or a part of the functions of the above-described embodiments may be realized by having the program, readout from the storage media, written into a memory provided on a function extension board inserted into a computer or a function extension unit connected to the computer. In such cases, after the program is written into the function extension board or the function extension unit, all of or a part of the actual processing is performed by a CPU or the like provided on the function extension board or the function extension unit according to instructions from the program.

According to the present invention, users will be able to display contents of moving images in a easier manner in a state where overlapping list display which allows overlapping of portions of images is performed, in order to efficiently list-display a large quantity of images on a screen.

While the present invention has been described with reference to exemplary embodiments, it is to be understood that the invention is not limited to the disclosed exemplary embodiments. The scope of the following claims is to be accorded the broadcast interpretation so as to encompass all such modifications and equivalent structures and functions.

This application claims the benefit of Japanese Patent Application No. 2005-264437 filed on Sep. 12, 2005, which is hereby incorporated by reference herein in its entirety.

What is claimed is:

1. An image display method for list-displaying a plurality of images, comprising:
an acquisition step for acquiring an attention area in an image;
a determination step for respectively determining a display position for each of the plurality of images so that the plurality of images overlap each other while the attention areas acquired in the acquisition step are entirely exposed; and
a display control step for list-displaying the plurality of images by laying out each of the plurality of images to the display positions determined in the determination step.

2. The method according to claim 1, wherein the acquisition step comprises:
a first determination step for determining an attention area in a still image; and
a second determination step for extracting attention areas from a plurality of frame images contained in a moving image, and determining a logical OR of the attention areas as an attention area of the moving image.

3. The method according to claim 1, wherein:
in the acquisition step, the attention area is determined based on a face area detected from a still image or a frame image of a moving image.

4. The method according to claim 1, wherein:
in the acquisition step, attention areas are extracted from all frames contained in a moving image.

5. The method according to claim 1, wherein:
in the determination step, images are selected in descending order of the dimensions of the acquired attention areas, and layout positions of the selected images are determined so that the attention areas of the selected images do not overlap with images which have already been laid out.

6. The method according to claim 1, further comprising:
a selection step for selecting frames, from which attention areas are to be extracted in the acquisition step, based on a frame rate of the moving image.

7. The method according to claim 1, wherein:
the determination step determines a logical OR of attention areas extracted from the frame images of the moving image to be an attention area of the moving image when the logical OR reaches or exceeds a predetermined proportion of the size of frame images.

8. The method according to claim 1, further comprising:
a judgment step for monitoring temporal changes in attention areas of moving images among the plurality of images list-displayed in the display control step, and judging whether the attention areas are now overlapping with other images; and
an updating step for updating layout of images in the list display, when a moving image exists which has an attention area judged by the judgment step to overlap with other images, so that the entire attention area becomes exposed.

9. An image display method for list-displaying a plurality of images, comprising:
a display control step for list-displaying the plurality of images so that portions thereof are overlapping;
an extracting step for extracting an attention area from an image;
a judgment step for determining whether the attention area extracted in the extracting step overlaps with other images; and
an updating step for updating the list display state when the attention area is judged to be overlapping with other images in the judgment step so that the attention area becomes exposed.

10. The method according to claim 9, wherein:
in the extracting step, an attention area is extracted from a currently reproduced frame image contained in a moving image.

11. The method according to claim 9, wherein:
the updating step moves a moving image, having an attention area judged to be overlapping with other images, to the forefront.

12. The method according to claim 9, wherein:
the updating step changes the displayed size of an image, having an attention area judged to be overlapping with another image, to a size where the attention area no longer overlaps with other images.

13. An image display apparatus for list-displaying a plurality of images, the apparatus comprising:
an acquisition unit adapted to acquire an attention area in an image;
a determination unit adapted to respectively determine a display position for each of the plurality of images so that the plurality of images overlap each other while the attention areas acquired by the acquisition unit are entirely exposed; and
a display control unit adapted to list-display the plurality of images by laying out each of the plurality of images to the display positions determined by the determination unit.

14. An image display apparatus for list-displaying a plurality of images, the apparatus comprising:
a display control unit adapted to list-display the plurality of images so that portions thereof are overlapping;
an extracting unit adapted to extract an attention area from an image;
a judgment unit adapted to determine whether the attention area extracted by the extracting unit overlaps with other images; and
an updating unit adapted to update the list display state when the attention area is judged to be overlapping with other images by the judgment unit so that the attention area becomes exposed.

15. A control program stored in computer readable medium, for having a computer execute the image display method according to claim 1.

16. A control program stored in a computer readable medium, for having a computer execute the image display method according to claim 9.

17. A storage media which stores the control program according to claim 15.

18. A storage media which stores the control program according to claim 16.
